(19) United States
(12) Patent Application Publication
(10) Pub. No.: US 2004/0260602 A1
(43) Pub. Date: Dec. 23, 2004

(54) System for business service management and method for evaluating service quality of service provider

(75) Inventors: Toshihiro Nakaminami, Zama (JP); Makoto Kitagawa, Fujisawa (JP); Susumu Kobayashi, Kawasaki (JP); Toshiaki Tokunaga, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/648,722

(22) Filed: Aug. 25, 2003

(30) Foreign Application Priority Data
Jun. 19, 2003 (JP) 2003-174234

(51) Int. Cl. G06F 17/60

(52) U.S. Cl. 705/11

(57) ABSTRACT

In an enterprise that has built a business flow by using a plurality of service providers, a manager is allowed to monitor and evaluate services provided by such service providers from a business viewpoint, thus reducing burdens incurred at the time of improving a business flow according to an evaluation index.

A monitoring/evaluation information designator designates a message to be monitored and a history to be monitored, and a business service information collector on each service provider sends information to be monitored to a business service level analyzer according to each transaction. Next, the business service level analyzer evaluates a business service based on information collected. The manager identifies a problematic business service or a problematic business flow based on the evaluation index, and requests a business process management to retrieve an alternative business service or business flow. Then, an instruction to change the entire business flow is transmitted to each service provider via the business process management based on the retrieval result.

### BACKGROUND OF THE INVENTION

The present invention relates to a system that uses a service provider.

Business systems are nowadays being outsourced in many countries at an accelerating pace. For such outsourcing of business systems, an enterprise providing a business system (service provider) obtains trust from client enterprises by committing (SLA: Service Level Agreement) a certain level of performance (response, throughput, availability, etc.).

On the other hand, a business manager who expects more streamlined and value-added business by using a service provider has a need to monitor and evaluate the service provider as well as to restructure the business flow in quick and simplified manners.

Examples of methods for monitoring whether or not actual system performance satisfies the SLA include a method in which “Automated SLA Monitor (ASM)” finds out a job that causes delay in the SLA and notifies the impact of such job.

[Patent Document 1] U.S. Pat. No. 5,893,905

In the aforementioned patent document, for example, runtime is monitored as the system performance. However, the document does not refer to methods for monitoring/evaluating results of processing that is executed by a job. More specifically, methods for monitoring/evaluating business information (contents of messages, history information, etc.) which is positioned in a higher layer than system information of a job that can be offered by the OS are not taken into consideration therein.

In addition, methods for monitoring/evaluating services that are realized by a plurality of transactions or a plurality of service providers as well as service providers that make up services are also not taken into consideration in the document, even if the methods relate to the system performance. Consequently, the system proposed in the aforementioned patent document has a problem that a manager of an enterprise which utilizes service providers cannot monitor/evaluate provided services at a business level, thus making it difficult to understand problems inherent in the business.

Further, in the patent document 1, a method of reconstructing a business flow which includes a problematic job or a service provider is not taken into consideration. As a result, the proposed system has a problem that, even if a manager of a client enterprise would be able to monitor/evaluate such service provider, it is difficult for the manager to change the business flow according to the monitoring/evaluation results.

More specifically, in terms of means for improving business performance to be taken by a manager of an enterprise utilizing service providers, prior arts have the following problems.

It is difficult to know problematic areas in a business flow since there is no means of monitoring/evaluating services that are provided by service providers at a business level.

Further, even if monitoring/evaluation of service providers would be possible, it is difficult to change a business flow according to the results thereof.

### SUMMARY OF THE INVENTION

The object of the present invention is, at an enterprise which has built a business flow using a service provider, to enable a manager to monitor/evaluate a service provided by the service provider for the entire business flow at a business level that has not been possible with the SLA monitoring performed by using prior arts, and further to reduce burdens in performing changes in the business flow.

The present invention relates to a method for evaluating a service provider by using a computer, such computer performing the steps of: storing information on an item of data of a history related to a transaction that is acquired by the service provider when a service provided by the service provider is used; storing items to be monitored including an item of data used for evaluating the service provided by the service provider; acquiring the data, from the service provider, of a history related to transactions that are to be acquired by the service provider; evaluating the service provided by the service provider based on the acquired data of a history related to a transaction that is acquired by the service provider and the item of data included in the aforementioned items to be monitored; and outputting a result of the above-stated evaluation.

In addition, according to the present invention, a person to designate monitoring/evaluation information designates a message and a history to be monitored out of those that are generated in the communication processing to use each service provider, and a business service information collector on each service provider sends information to be monitored to a business service level analyzer whenever a transaction is generated. Then, the business service level analyzer evaluates the business service based on information thus collected. On the other hand, a manager identifies a problematic business service or a business flow based on an evaluation index (BSL information), and requests business process management to retrieve an alternative business service or an alternative business flow. At this time, the business process management retrieves business services or business flows that are pertinent to the retrieval conditions out of registries, and notifies the manager of the result. Lastly, the manager instructs each service provider via the business process management to change the entire business flow based on the retrieval result.

### BRIEF DESCRIPTION OF THE DRAWINGS

FIG. 1 is a conceptual diagram showing a system configuration of a preferred embodiment;

FIG. 2 shows an interface to change a business service or a business flow;

FIG. 3 is a diagram illustrating a system configuration and a processing flow to determine a message to be monitored and a history to be monitored;

FIG. 4 is a diagram illustrating a system configuration and a processing flow to notify, collect and evaluate business service information;

FIG. 5 is a diagram illustrating a data configuration of service definition;

FIG. 6 is a detailed diagram illustrating a data configuration of connection specification;

FIG. 7 is a detailed diagram illustrating a data configuration of message data;

FIG. 8 is a detailed diagram illustrating a data configuration of server history specifications;

FIG. 9 is a detailed diagram illustrating a data configuration of client history specifications;

FIG. 10 shows an interface to designate a monitoring destination;

FIG. 11 shows an interface to designate a message to be monitored;

FIG. 12 shows an interface to designate a monitor history;

FIG. 13 is a diagram illustrating a data configuration of BSL information;

FIG. 14 shows an interface to grant authority accessing a BSL analyzer and a registry user;

FIG. 15 is a diagram illustrating a data configuration of analyzer security information;

FIG. 16 is a diagram illustrating a data configuration of user security information;

FIG. 17 is a system configuration diagram and a processing flow for changing a business service or a business flow;

FIG. 18 shows an interface to display evaluation information;

FIG. 19 shows an interface to retrieve a service or a flow;

FIG. 20 is a diagram related to a data configuration of flow definition and data updating;

FIG. 21 is a detailed diagram illustrating a data configuration of service data;

FIG. 22 shows an interface to display a retrieval result of a service or a flow;

FIG. 23 is a diagram illustrating a data configuration of a node history definition;

FIG. 24 shows an interface to create a mapping definition of a message and a history;

FIG. 25 is a diagram illustrating a data configuration of a mapping definition;

FIG. 26 is a conceptual diagram showing a system configuration of a message conversion processor;

FIG. 27 is a conceptual diagram showing a system configuration of a message reception processor; and

FIG. 28 is a conceptual diagram showing a system configuration of a message transmission processor.

### DESCRIPTION OF THE PREFERRED EMBODIMENTS

Hereinafter, preferred embodiments (examples) of the present invention will be described in detail with reference to the drawings.

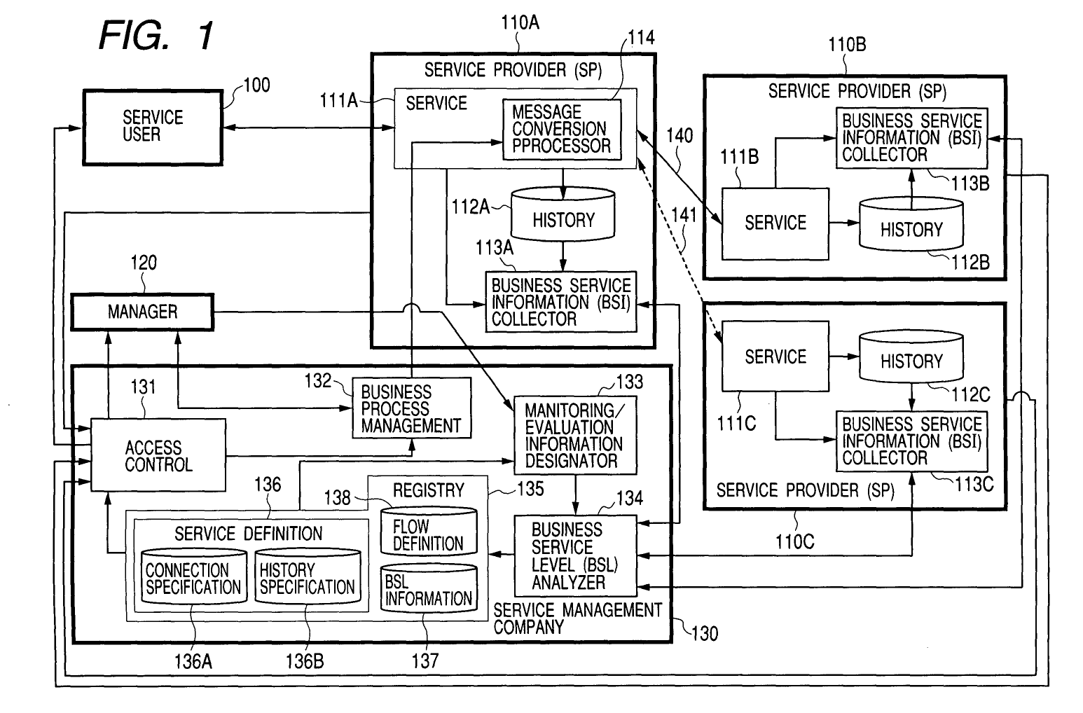

FIG. 1 shows the outlined system configuration of a preferred embodiment.

The system exemplifies a system which is designed, in an enterprise that has built a business flow by using a service provider, to enable a manager to monitor/evaluate services provided by the service provider from business viewpoints, and reduce burdens to be incurred at the time of improving a business flow according to an evaluation index (business service level information (BSL information)).

Major components constituting the system include the following:

A service user 100 (or a computer or a system 100 located at the service user) is an individual or a corporation (or a computer, a system, etc. to be used by the individual or the corporation), and the service user 100 uses a service provided by an SP (service provider) 110A. The service user 100 refers to BSL (Business Service Level) information or retrieves services through a service management company 130. In FIG. 1, the service user 100 is independent of the SPs 110A, 110B, 110C and the service management company 130, but it may be so structured that the service user is subordinate to the SPs. For example, the service user may belong to either one of the three SPs, or the service user itself 100 may be an SP.

The SP 110A executes processing to provide a service to the service user 100 in a service 111A, executes processing to use the SP 110B and 110C, and acquires a transaction history at the time of executing such processing in a history 112A. Further, business service information (hereinafter referred to as the “BSI” (Business Service Information)) collector 113A acquires monitoring information each time a transaction is made, and notifies a business service level (BSL: Business Service Level) analyzer 134 of the information.

The BSL analyzer 134 evaluates a business service level based on such monitoring information collected. In addition, communication processing with the SP 110B or the SP110C is performed in a message conversion processor 114. A coupling 140 in a solid line between the SP 110A and the SP 110B indicates a communication path before a flow change, and a coupling 141 in a dotted line between the SP 110A and the SP 110C indicates a communication path after a flow change.

The instruction for changing the flow is executed by transmitting data for changing instruction from a computer, etc. that is used by a manager 120 (or a system located on the side of the manager 120). The change processing of a communication path is executed at the message conversion processor 114 based on the data for changing instruction.

The SPs 110B and 110C each basically have the same structure as that of the SP 110A.

By aggregating a plurality of SPs (SP 110A, SP 110B and SP 110C) stated in the above, using services mutually by such SPs, and forming a flow, a new hybrid type of service can be provided.

It should be noted that, in FIG. 1, the SPs 110A, 110B and 110C are arranged independently, but the structure may be so arranged that an SP provides a plurality of services and the services are mutually used among the SPs. A BSI collector does not necessarily have to correspond to a SP in a paired manner. Further, a BSI collector may be responsible for a plurality of SPs, or adversely, an SP may provide a plurality of BSIs with monitoring information.

The manager 120 is an individual or a corporation that manages an SP, and the manager refers to BSL information, retrieves services, changes a service flow and registers monitoring information through the service management company 130. The manager 120 is basically a person who belongs to an enterprise which uses or provides an SP like the SP 110A and is in a position engaged in the management or business improvement of the SP 110A, but the manager may take procedures similar to procedures that are executed for the SP 110A for any SPs to which the manager 120 involved in the flow does not belong.

The service management company 130 is an enterprise or a system which is in a position to give an instruction to each SP. The service management company includes: a registry 135 storing a service definition 136, BSL information 137 and a flow definition 138; a monitoring/evaluation information designator 133 who designates a definition of monitoring information or the BSL information 137 to the BSL analyzer 134; a BSL analyzer 134; a business process management 132 which improves a business flow according to an instruction from the manager 120; and an access control 131 which prevents individual or corporate information from being leaked by restricting accesses to the registry by the service user 100 or the manager 120.

Upon receiving a request from the manager 120, the monitoring/evaluation information designator 133 selects information to be monitored on an SP out of connection specification 136A or history specification 136B that is available in the service definition 136, and requests the BSL analyzer 134 to register the monitoring information.

The BSL analyzer 134 that received the request for monitoring designates monitoring items to the BSI collector 113A or 113B in SP 110A or SP 110B to be monitored, analyzes BSI that will be subsequently transmitted to the analyzer, and registers such information in the registry 135 as the BSL information 137.

As stated above, the BSL analyzer 134 is a vital unit in deriving the BSL information 137, and because the BSL information 137 exists, the manager 120 can objectively evaluate SPs, services in the SPs, or the business flow.

On the other hand, the BSI collectors 113A, 113B and 113C, when monitoring items are designated, notifies the access control 131 of information on authority accessing the BSL information 137 created by using BSI that is transmitted based on such monitoring items. In addition, the manager 120 identifies the SP 110B that will be a bottleneck (e.g. performance bottleneck; the business evaluation level is low; or the business flow has been turned to be a structure that does not produce profit any more), retrieves an alternative SP 110C through the business process management 132 with the BSL information 137, service definition 136 or the flow definition 138 being the conditions for the retrieval, and notifies the message conversion processor 114 of the SP 110A of an instruction for changing the flow.

As stated above, the service management company 130 is able to build a flow as anticipated by the manager 120, by designating a connecting destination or items to be monitored of each SP. In other words, the service management company 130 can be an entity that coordinates SPs. The existence of the service management company 130 enables each SP to be solely involved in faithfully providing its own services and manages the connecting destination of its own, thus eliminating necessity to think of the consistency as an entire flow or business efficiency.

It should be noted that all of the business process management 132, the BSL analyzer 134 and the registry 135 may not always exist in the service management company 130. Each of them may belong to an independent enterprise, or a plurality of them may exist in the service management company 130.

It should also be noted that a flow configured with the SPs 110A, 110B and 110C illustrated in FIG. 1 is just an example, and other flows with a more complicated or simplified configuration may be formed.

The system is configured with communication means such as a computer and the Internet, and data processing performed with the system is realized by executing a program on the computer machine.

The following description shows that the above-stated components execute data processing, and such data processing is realized by executing a program on a computer that associates with each of such components.

Each element stated above executes data provision and reception that are described in the following. Such data provision and reception are performed through communication means including the Internet.

Such programs are stored in storage media such as a hard disk unit and a CD-ROM disk which can be read and written with computers, and access to the programs is made through communication means including the Internet.

More specifically, the system can be realized with communication means including a computer and the Internet.

Hereinafter, the outlined flow of data processing for monitoring/evaluating a business service and changing the flow in the system will be described.

Note that, however, the description of an example shown below only refers to major items out of those related to business service management. Because of making a description by focusing on the idea, details of data to be stored in the registry or history data to be monitored by an SP, details of messages, and likewise, items that can be data-processed are omitted. Although not being described in the following example, the items that can be data-processed include, for example, a business service that is produced by administrative tasks of an enterprise (personnel, general affairs and material order placement tasks). Items exemplified herein are only for the purpose of easier understanding and are not limited to those shown in the following example.

Hereinafter, processing that is arranged for use by the financing service of a bank will be described.

Financing service implies a series of business services wherein, when an individual or a corporation gets a loan from a bank, the bank examines the person or the corporation requesting for the loan,-determines whether financing is possible or not, the amount to be financed, the rate of interest for the loan, etc., and collects debts after executing the financing.

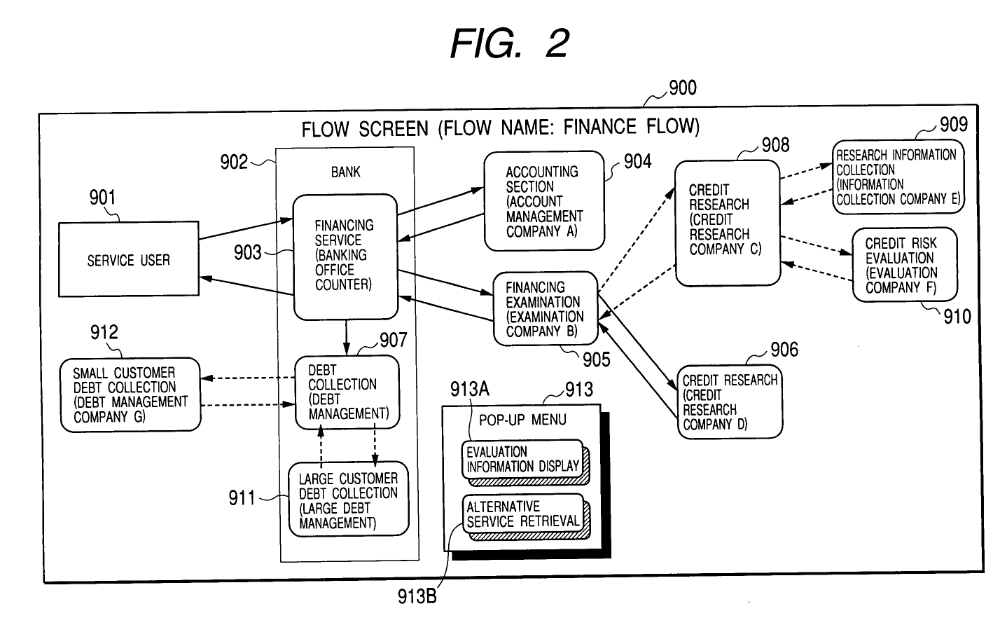

Hereinafter, the outlined flow of financing to be referred to herein will be described with reference to FIG. 2.

Note that components configuring the business flow may include a service provider, a service to be provided by a service provider, a computer of a system for the service to be provided by the service provider, a program for the service to be provided by the service provider, and processing to provide the service, or may be of other components. Further, the business flow may include not only stand-alone components, but also a plurality of sequenced processing or business flows, and the like (sub-flow), or may be of other flows.

A bank 902 coordinates sub-tasks at the time of realizing a financing service, and plays a role of office counter work to receive a direct request for financing from a service user 901.

The bank 902 first receives a request for financing at a financing service 903, and the financing service 903 requests a financing examination 905 to examine the service user 901. Then, the financing examination 905 requests a credit research 906 to research the service user 901, determines financing conditions for the service user 901 based on the research result, and returns the result to the financing service 903. The financing service 903 requests an accounting section 904 for deposit processing to the service user 901. Thereafter, the financing service 903 requests a debt collection 907 for collection processing of the fund financed.

Referring to each SP configuring the flow or the BSL information 137 of a service thereof, the manager 120 judges that the flow provided by a research company C 908 provides a higher quality business than that of a credit research service provided by a research company D 906, and decides to change the research company of which credit research service is used to the research company C 908. The research company C908, in addition to the above-stated flow, collects information on the service user 901 by using a highly specialized service of research information collection 909 and also using a service of credit risk evaluation 910 which provides highly reliable evaluation value based on abundant information, thus forming a flow to calculate the bad debt risk of the service user 901.

In addition, by retrieving an outsourcing service for debt collection, the manager 120 finds a debt management company G 912 which provides a small customer debt collection service, but is less-experienced in collecting debts. The manager 120 decides that, for the time being, only the debt collection from small customers will be handled by the debt management company G 912, and for large customers, a node of large debt management 911 which specializes in handling debt collection from large customers will be newly established in the bank 902.

It should be noted that a flow screen 900 will be described in detail later in the description for the “change flow phase.” In addition, a node implies an element contained in a business flow. The business flow may include a node, a plurality of nodes, or other components.

Hereinafter, monitoring/evaluation of a business service as well as change flow processing thereof will be described in the following five phases.

In a “monitoring item registration phase”, a message or a history item of the SP to be monitored is designated and registered in the BSI collector.

In a “BSI collection phase”, information associating with monitoring item is collected, and the collected information is transmitted to the BSL analyzer.

In a “BSL analysis phase”, BSI acquired from the BSI collector is analyzed, and BSL information is generated and registered.

In a “change flow phase”, the flow is changed based on the BSL information.

In a “new flow formation phase”, communication processing is executed for forming a new flow.

As stated above, by collecting history of messages or processing that is transmitted or received by a service provider, analyzing information thus collected, whereby analyzing the level of the business service and outputting results of such analysis, it is possible to use such data for evaluation of business services, etc.

First, the “monitoring item registration phase” executes the following:

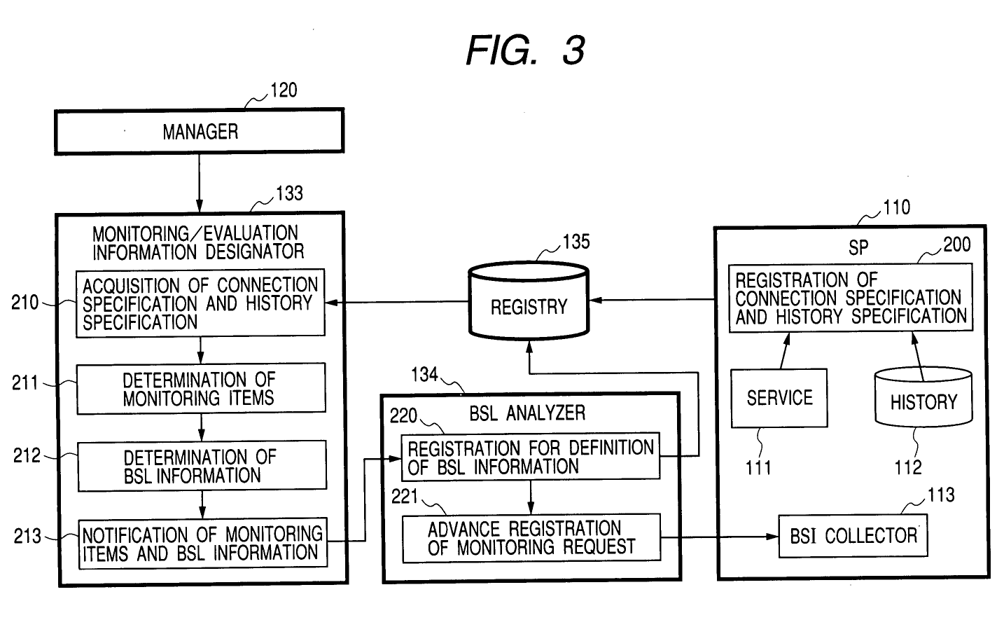

As shown in FIG. 3, the SP 110 registers connection specification (including interface information and communication protocol information required for data communication with the program 111) to the service 111 (or the program 111 which provides a service) and a definition that may be disclosed externally among table definitions of a history 112 (or a history 112 of processing of the program 111) that is acquired within a service provider to the registry 135 as a history specification via the processing of registrations of the connection specification and the history specification 200.

The connection specification and the history specification thus registered are stored in the registry 135 as a connection specification 136A (to be described later) and a history specification 136B (to be described later) respectively in the service definition 136 (to be described later).

Thereafter, the manager 120 performs the following processing through the monitoring/evaluation information designator 133 (or a monitoring/evaluation information designator 133 incorporated in a computer system that is used to designate monitoring/evaluation information).

First, the manager 120 designate the SP 110 to be monitored out of the registry 135 via the processing of the acquisition of connection specification and history specification 210 by using a monitoring destination designation screen 700, and acquires the connection specification 136A and the history specification 136B of the designated SP 110 from the registry.

Thereafter, the manager 120 determines monitoring items by using a monitoring message designation screen 500 (to be described later) and a monitoring history designation screen 600 (to be described later) (determination processing 211 of monitoring item), receives data of monitoring items determined, and performs the determination processing 212 of the BSL information 137 based on the data received.

Upon determining the monitoring items and the BSL information 137 (to be described later), the manager 120 notifies the BSL analyzer 134 of definition information of the monitoring items and the BSL information 137 through the processing of notification of monitoring items 213 and BSL information. At the same time, the manager 120 determines to which user the BSL information to be generated based on the BSI may be disclosed, and updates user security information 323 (to be described later) through access authority registration 320.

The BSL analyzer 134 who is notified of monitoring items registers definition information of the BSL information 137 to the registry 135 via the registration for definition of BSL information 220, and then transmits data requesting monitoring to the BSI collector 113 via the processing of the advance registration of monitoring request 221.

Note that, however, the above stated respective processing of acquisition of connection specification and history specification 210, the determination 211 of monitoring items 211, the determination of BSL information 212 and the notification of monitoring items and BSL information 213 may be provided as different modules in the form of a program, or may be of any others. In addition, such data that is received from a user at the time of processing the monitoring item determination 211 or the determination of BSL information 212 may be sent and received via a network.

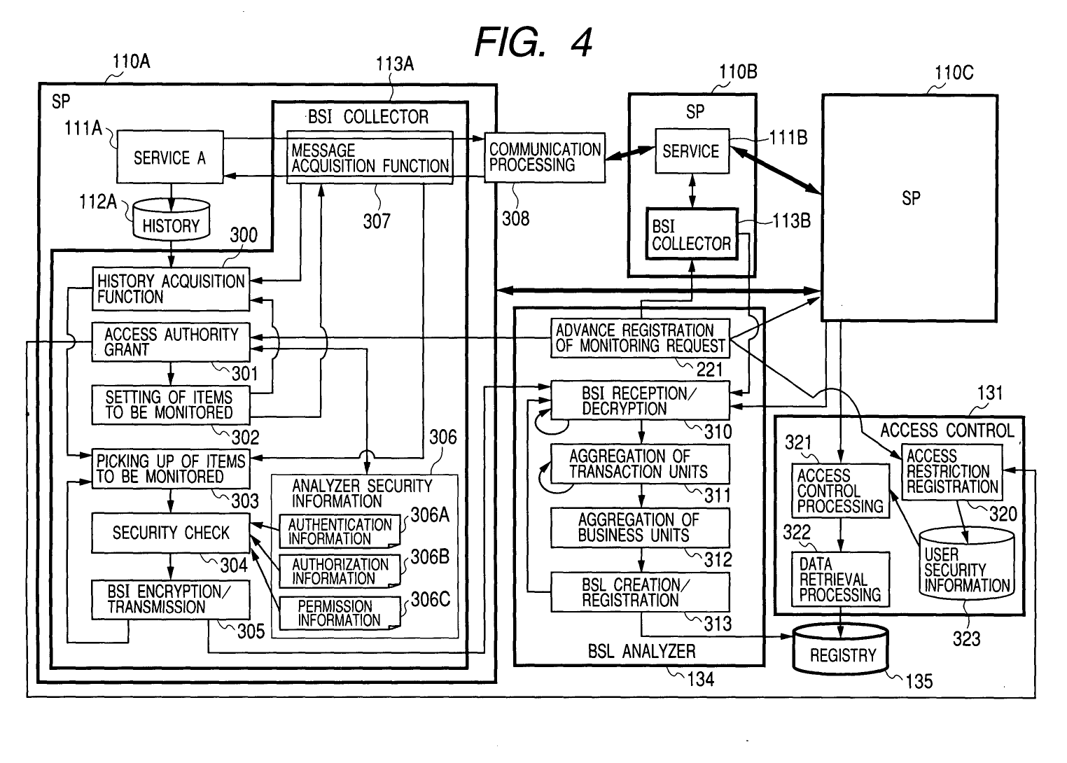

As shown in FIG. 4, the BSI collector 113A which received a monitoring request refers to and updates analyzer security information 306 (to be described later) and the user security information 323 via an access authority grant screen 800 (to be described later) in the processing of access authority grant 301. The processing procedures will be described hereunder. First, the BSI collector refers to authentication information 306A and authenticates the BSL analyzer 134. Then, the BSI collector determines whether or not items that are requested to be monitored may be sent to the BSL analyzer 134, and if the items may be sent, the BSI collector updates authorization information 306B and permission information 306C (details to be updated will be described later).

Likewise, the BSI collector determines to which user the BSL information to be generated based on the BSI may be disclosed, and updates the user security information 323 through access authority registration 320. Here, the access control 131 executes an access restriction to the registry, and a person who accesses the registry from outside the service management company 130 must be authenticated and authorized at access control processing 321 before referring to information thorough data retrieval processing 322.

Next, the BSI collector 113A sets a message item to be monitored in a message acquisition function 307, and then sets a history item to be monitored in a history acquisition function 300, through the processing of setting of items to be monitored 302.

Hereinafter, the service definition 136, the connection specification 136A, the history specification 136B, the monitoring destination designation screen 700, the monitoring message designation screen 500, the monitoring history designation screen 600, the BSL information 137, the access authority grant screen 800, the analyzer security information 306, and the user security information 323 will be described in detail in sequence.

With such items, the manager 120 can notify of items the BSI collector which monitors respective SPs, just by specifying items that have been monitored throughout the entire flow by use of only the BSL analyzer 134.

First, the service definition 136 will be described.

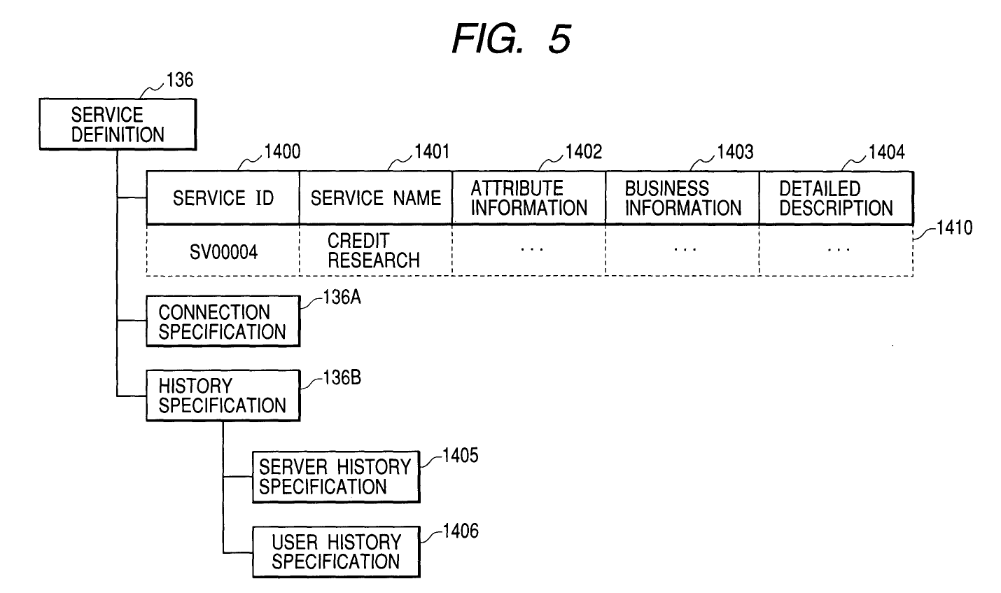

As shown in FIG. 5, the service definition 136 comprises a service ID 1400 uniquely identifying a service, a service name 1401, attribute information 1402 of a node that provides a service, business information 1403 which indicates the business field of a service, a detailed description 1404 in which information concerning a service that cannot be turned into a regular format is attached in a free format, a plurality of connection specifications 136A making up a service, and a plurality of history specifications 136B making up a service. FIG. 5 exemplifies credit research service information 1410, wherein the service ID is “SV0004” and the service name is “credit research.”

In addition, the history specification 136B further comprises a plurality of server history specifications 1405 which is history information that is acquired by a server providing a service, and a plurality of client history specifications 1406 which is history information that is acquired by a client using the service. It should be noted that the connection specification 136A and the history specification 136B are basically associated with each other with a message name 1503 (to be described later), but such histories 136A and 136B may be associated with each other with a message type 1500 (to be described later) or the service ID 1400.

Next, the connection specification 136A will be described.

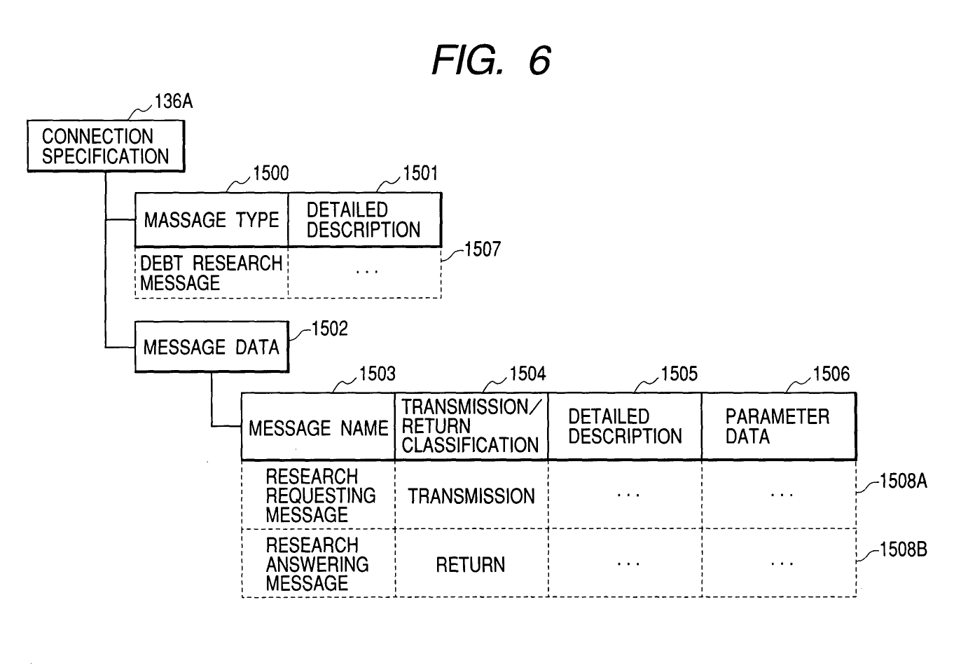

As shown in FIG. 6, the connection specification 136A comprise the message type 1500 which shows a transaction in a service, detailed description 1501 of the message type 1500 by using a free format, and a plurality of message data 1502 constituting the message type.

In addition, the message data 1502 further comprise a message name 1503, transmission/return classification 1504 indicating the classification of a transmission message or a return message, detailed description 1505 of the message name 1503 by using a free format, and a plurality of parameter data 1506 constituting the message data 1502. Note that the message data 1502 exemplify a transaction, and an assembly of a plurality of message data constitutes the message type 1500 showing one transaction. Generally, a transmission message or a return message respectively corresponds to the message data 1502, and a pair of transmission/return messages corresponds to the message type 1500. For example, examples 1508A and 1508B show that if they transmit a “research requesting message” to an SP as a transmission message, a “research answering message” is returned to a client. While the example 1507 shows that a pair of these messages are defined as a “credit research requesting message.”

Next, the parameter data 1506 will be described by taking the “research requesting message” of the example 1508A as an example.

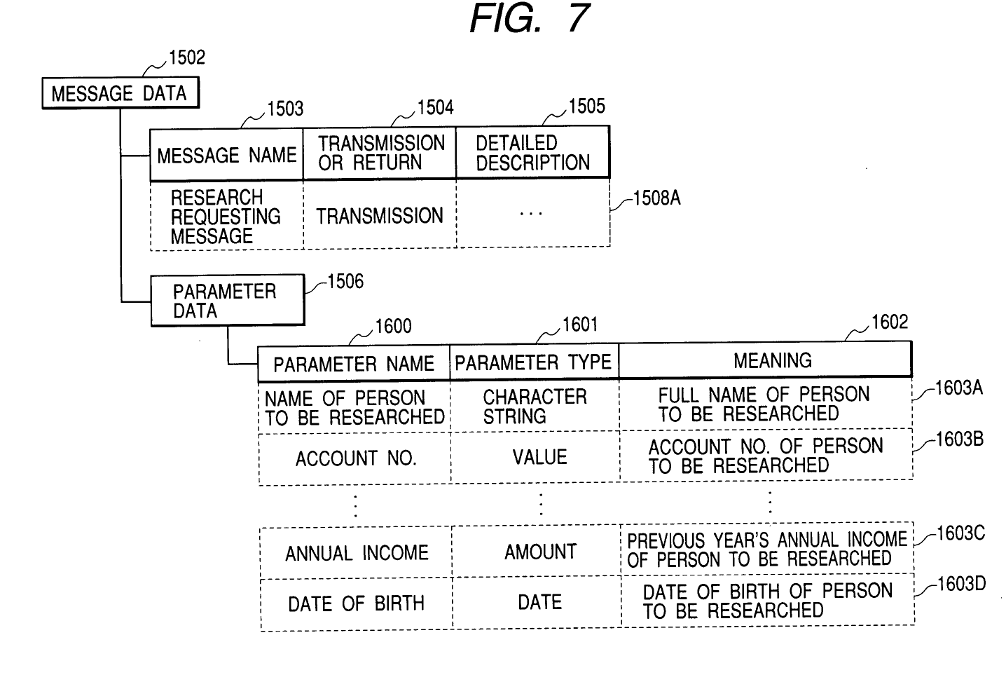

As shown in FIG. 7, the parameter data 1506 comprise a parameter name 1600, a parameter type 1601, and a meaning 1602 which describes the parameter name 1600 by using a free format. More specifically, the research requesting message comprises examples 1603A, 1603B, 1603C, 1603D. The example 1603A indicates that the parameter name is “name of person to be researched”, the parameter type is “character string”, and the meaning is “full name of person to be researched”. The example 1603B indicates that the parameter name is “account No.”, the parameter type is “value”, and the meaning is “account No. of person to be researched”. The example 1603C indicates that the parameter name is “annual income”, the parameter type is “amount”, and the meaning is “Previous year's annual income of person to be researched”. Lastly, the example 1603D indicates that the parameter name is “date of birth”, the parameter type is “date”, and the meaning is “date of birth of person to be researched.”

Next, the server history specification 1405 will be described.

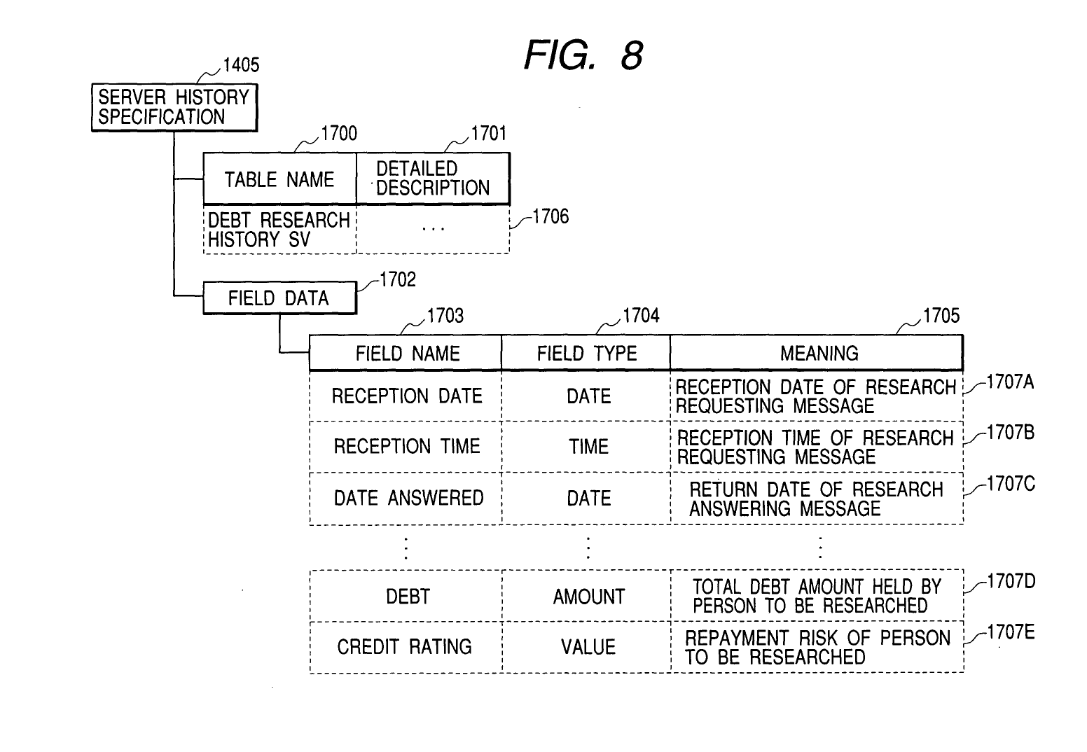

As shown in FIG. 8, the server history specification 1405 comprises a table name 1700, a detailed description 1701 of the table name 1700 by using a free format, and a plurality of field data 1702. In an example 1706, the table name is “credit research history SV”, and the name indicates a history that is acquired by an SP providing a credit research service at the time of processing the credit research requesting message 1507.

In addition, the field data 1702 further comprise a field name 1703, a field type 1704, and a meaning 1705 which describes the field name 1703 by using a free format. More specifically, the credit research history SV comprises an example 1707A, an example 1707B, an example 1707C, an example 1707D, and an example 1707E. The example 1707A indicates that the filed name is “reception data”, the field type is “date”, and the meaning is “reception date of research requesting message”. The example 1707B indicates that the field name is “reception time”, the field type is “time”, and the meaning is “reception time of research requesting message”. The example 1707C indicates that the field name is “date answered”, the field type is “date”, and the meaning is “return date of research answering message”. The example 1707D indicates that the field name is “debt”, the field type is “amount”, and the meaning is “total debt amount held by a person to be researched”. Lastly, the example 1707E indicates that the field name is “credit rating”, the field type is “value”, and the meaning is “repayment risk of a person to be researched.”

Next, the client history specification 1406 will be described.

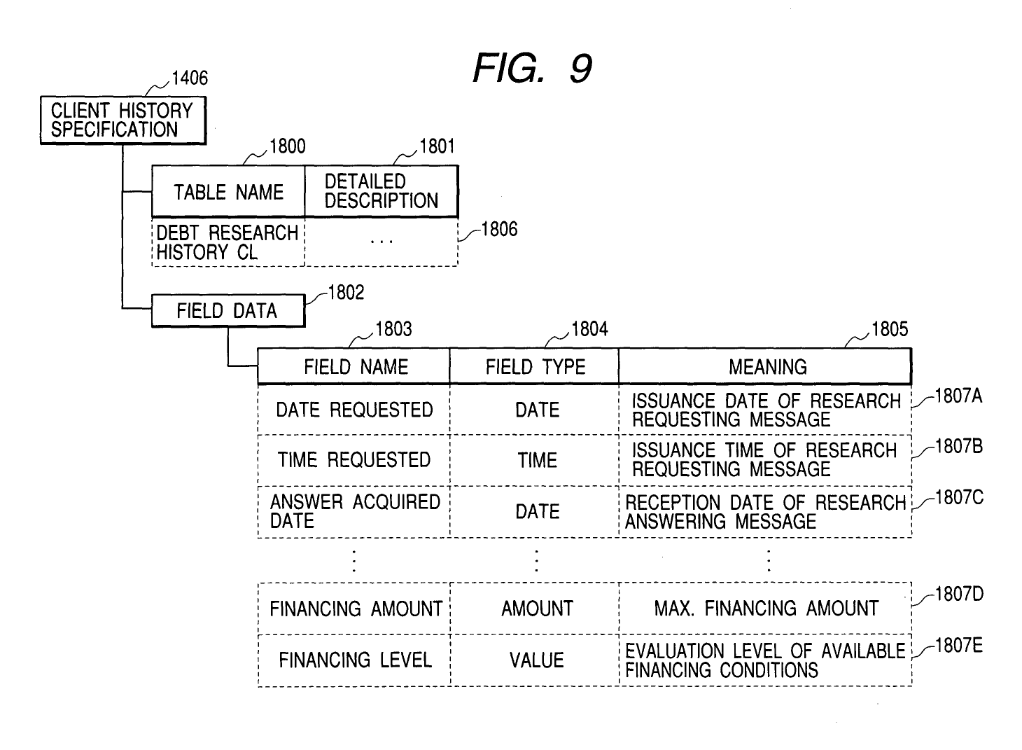

As shown in FIG. 9, the client history specification 1406, having totally the same structure as that of the server history specifications, comprises a table name 1800, a detailed description 1801, and a plurality of field data 1802. An example 1806 indicates that the table name is “credit research history CL”, thereby indicating a history that is acquired by a client using a credit research service at the time of using the credit research requesting message 1507.

In addition, the field data 1802 comprise a field name 1803, a field type 1804, and a meaning 1805. More specifically, the credit research history CL comprises an example 1807A, an example 1807B, an example 1807C, an example 1807D, and an example 1807E. The example 1807A indicates that the filed name is “date requested”, the field type is “date”, and the meaning is “issuance date of research requesting message”. The example 1807B indicates that the field name is “time requested”, the field type is “time”, and the meaning is “issuance time of research requesting message”. The example 1807C indicates that the field name is “answer acquired date”, the field type is “date”, and the meaning is “reception date of research answering message”. The example 1807D indicates that the field name is “financing amount”, the field type is “amount”, and the meaning is “maximum financing amount”. Lastly, the example 1807E indicates that the field name is “financing level”, the field type is “value”, and the meaning is “evaluation level of available financing conditions.”

Next, the monitoring destination designation screen 700 will be described.

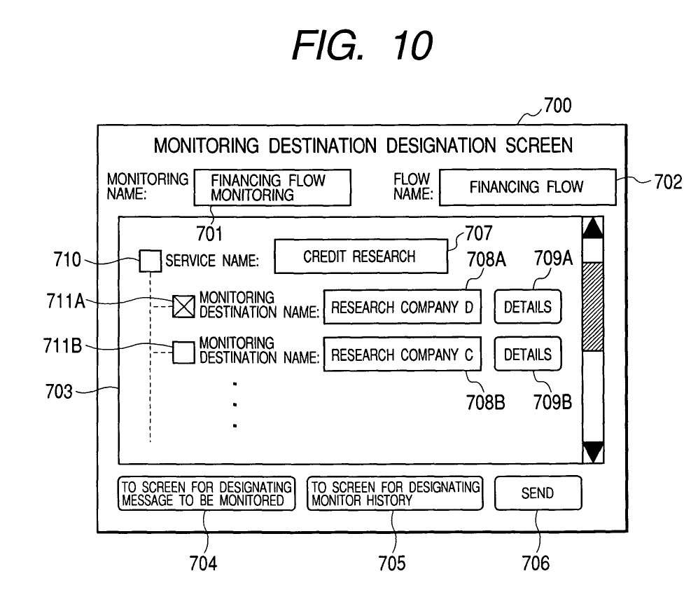

As shown in FIG. 10, the monitoring destination designation screen 700 comprises a label 700 which displays a monitoring name, a label 701 which displays a flow name to be monitored, a button “to screen for designating message to be monitored” 704 which is used to shift the screen to a monitoring message designation screen 500, a button “to screen for designating monitor history” 705 which is used to shift the screen to the monitoring history designation screen 600, a button 706 which is used to notify a monitoring item to the BSL analyzer 134, and a window 703 to display a list of nodes to be monitored. The example indicates that the monitoring name is “financing flow monitoring” and the flow name is “financing flow.”

The window 703 comprises a label 707 which displays a plurality of service names and labels 708A and 708B which respectively display a plurality of monitoring destination names (node names) that provide respective services. By ticking a check box 710 provided for the service name label 707, it is possible to enable all nodes providing appropriate services to be monitored. In addition, by ticking a check box 711A or 711B that is respectively provided for the node name label 708A or 708B, it is possible to designate an object to be monitored for each node.

In the example, the monitoring destination names are “research company C” and a “research company D” which provide a service name “credit research”, and the check box 711A is ticked. This means that the research company D will be monitored. In addition, when “details” buttons 709A and 709B that are provided next to the node name labels 708A and 708B are clicked, various attribute information of respective nodes will be displayed.

Note that respective interface components shown in FIG. 10 only exemplify an example to realize the monitoring destination designation screen 700. Alternatively, the label arrangement may be changed, or the window may be so structured that, by displaying a tier structure in the left pane, and, likewise, detailed information of respective items in the right pane. In either case, what is necessary is to enable handling of information similar to input and output information described here.

Next, the monitoring message designation screen 500 will be described.

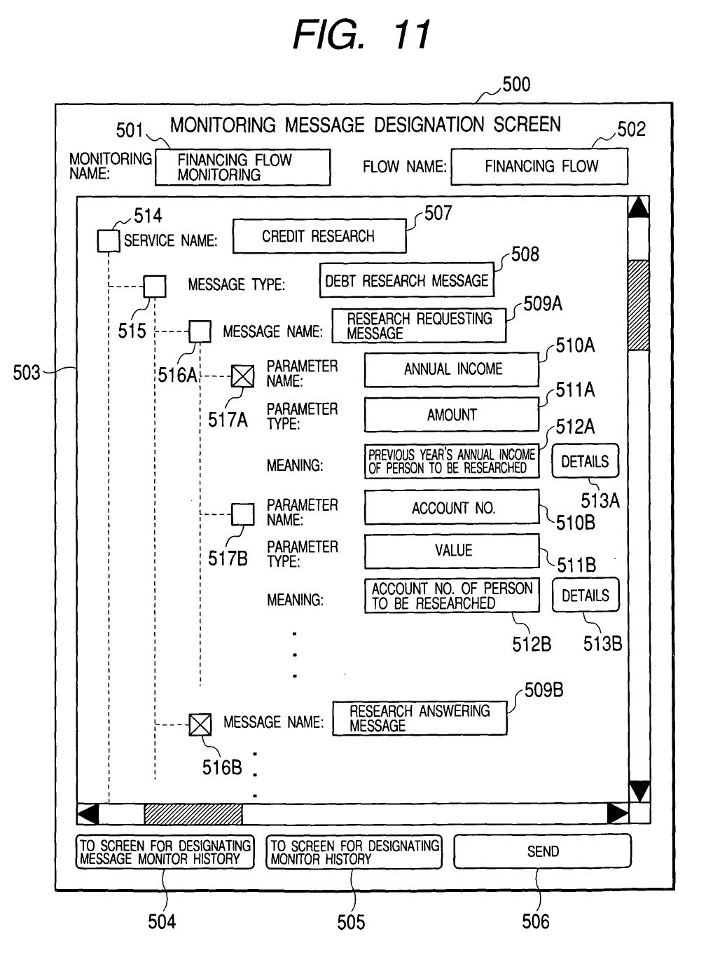

As shown in FIG. 11, the monitoring message designation screen 500 comprises a label 500 which displays a monitoring name, a label 502 which displays a flow name of an object to be monitored, a button “to screen for designating message monitor history” 504 which is used to shift the current screen to the monitoring history designation screen 600, a button “to screen for designating monitor history” 505 to shift the current screen to the monitoring destination designation screen 700, a “send” button 506 to notify the BSL analyzer of an object to be monitored, and a window 503 which displays a list of messages to be monitored. In the example, the monitoring name is “financing flow monitoring” and the flow name is “financing flow.”

The window 503 indicates the structure of the connection specification 136A almost as it is, and comprises a label 507 which displays a plurality of service names, a label 508 which displays a plurality of message types configuring respective services, labels 509A and 509B which respectively display a plurality of message names configuring respective message types, and labels 510A, 510B, 511A, 511B, 512A, and 512B which respectively display a plurality of parameter names, parameter types and meanings configuring respective message names. When a check box 514 provided next to the service name label 507 is ticked, it is possible to enable monitoring of all message names configuring an appropriate service. When a check box 515 provided next to the message type label 508 is ticked, it is possible to enable monitoring of all message names configuring a message type according to each message type.

In addition, by ticking a check box 516A or 516B that is respectively provided for the message name label 509A or 509B, it is possible to enable monitoring of all parameter names configuring a message name according to each message name. Likewise, by ticking a check box 517A or 517B provided for the parameter name label 510A or 510B, it is now possible to enable monitoring according to each parameter name.

The example displays the following: the message type name “credit research message” configuring a service name “credit research”; the message names “research requesting message” and “research answering message” configuring the “credit research message”; and the parameter name “annual income”, the parameter type “amount”, the meaning “previous year's annual income of person to be researched”, the parameter name “account No.”, the parameter type “value”, and the meaning “account No. of person to be monitored” configuring “research request message”. In addition, the check boxes 517A and 516B are ticked. This means that the annual income parameter and the research answering message will be monitored. In addition, when “details” buttons 513A and 513B provided next to the meaning labels 512A and 512B respectively are clicked, detailed information of respective parameters will be displayed.

Note that respective interface components shown in FIG. 11 only exemplify an example to realize the monitoring message designation screen 500. Alternatively, the label arrangement may be changed, or the window may be so structured that, by displaying a tier structure in the left pane, and, likewise, detailed information of respective items in the right pane. In either case, what is necessary is to enable handling of information similar to input and output information described here.

Next, the monitoring history destination screen 600 will be described.

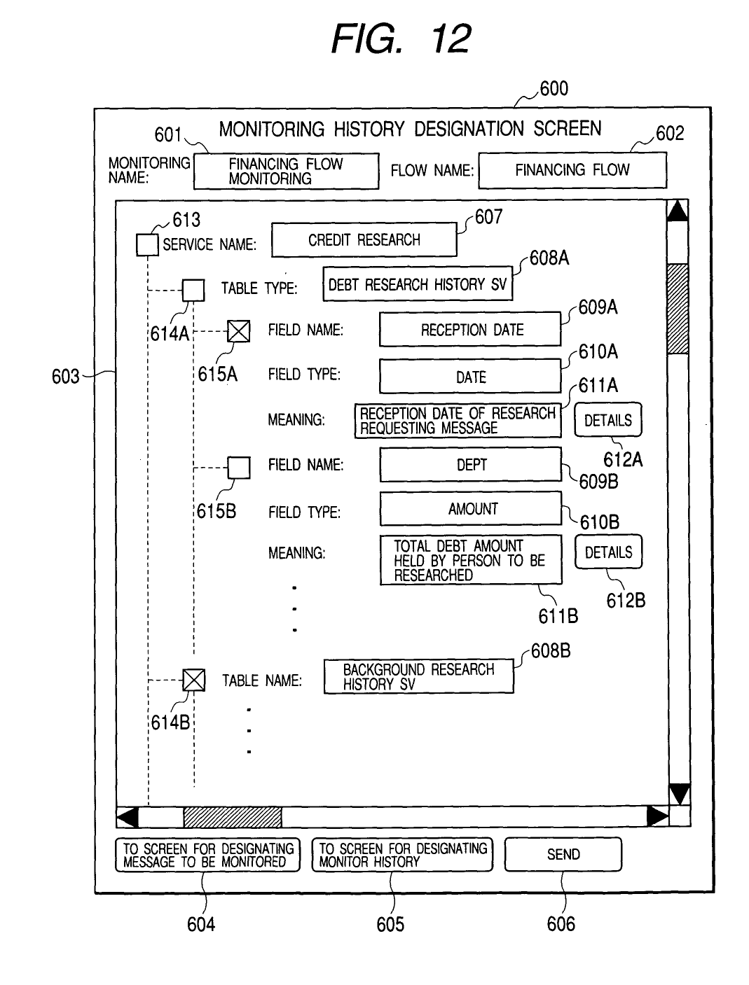

As shown in FIG. 12, the monitoring history destination screen 600 comprises a label 601 which displays a monitoring name, a label 602 which displays a flow name to be monitored, a button “to screen for designating message to be monitored” 604 which is used to shift the current screen to the monitoring message destination screen 500, a button “to screen for designating monitor history” 605 which is used to shift the current screen to the monitoring destination designation screen 700, a “send” button 606 to notify the BSL analyzer of an object to be monitored, and a window 603 which displays a list of histories to be monitored. In the example, the monitoring name is “financing flow monitoring” and the flow name is “financing flow.”

The window 603 indicates the structure of the history specification 136B almost as it is, and comprises a label 607 which displays a plurality of service names, a plurality of labels 608A and 608B which respectively display a plurality of table types configuring respective services, and labels 609A, 609B, 610A, 610B, 611A and 611B which respectively display a plurality of field names, field types, meanings configuring respective table names. When a check box 613 provided next to the service name label 607 is ticked, it is possible to enable monitoring of all message names configuring all table names that constitute appropriate services.

In addition, by ticking a check box 614A or 614B that is respectively provided for the table name label 608A or 608B, it is possible to enable monitoring of all field names configuring a table name according to each table name. Likewise, by ticking a check box 615A or 615B provided for the field name label 609A or 609B, it is now possible to enable monitoring according to each field name.

The example displays the following: table names “credit research history SV” and “background research history SV” configuring a service name “credit research”; and the field name “reception date”, a field type “date”, the meaning “reception date of research requesting message”, the field name “debt”, the field type “amount”, and the meaning “total debt amount held by person to be researched” configuring “credit research history SV”. In addition, the check boxes 615A and 614B are ticked. This means that the reception date field and the background research history SV will be monitored. In addition, when “details” buttons 612A and 612B provided next to the meaning labels 611A and 611B respectively are clicked, detailed information of respective fields will be displayed.

Note that respective interface components shown in FIG. 12 only exemplify an example to realize the monitoring history designation screen 600. Alternatively, the label arrangement may be changed, or the window may be so structured that, by displaying a tier structure in the left pane, and, likewise, detailed information of respective items in the right pane. In either case, what is necessary is to enable handling of information similar to input and output information described here.

Next, the BSL information 137 will be described.

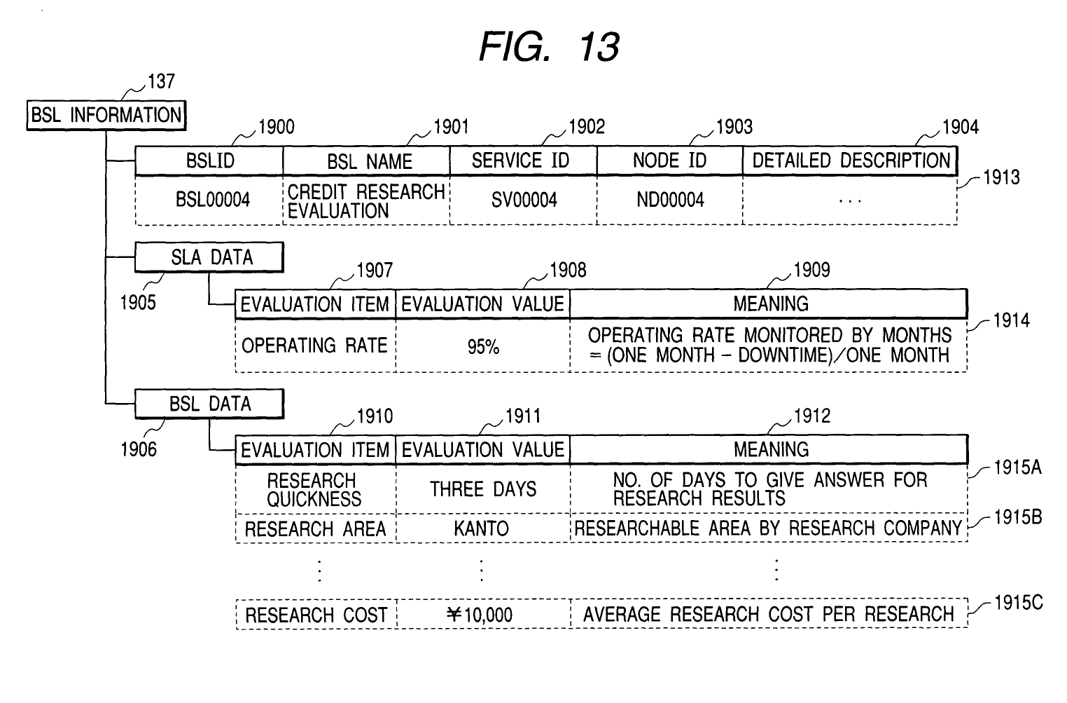

As shown in FIG. 13, the BSL information 137 includes a BSL ID 1900 uniquely identifying the BSL information, a BSL name 1901, a service ID 1902 to be monitored, a node ID 1903 to be evaluated, a detailed description 1904 of the BSL information 137, SLA data 1905 of a plurality of publicly-known information, and a plurality of BSL data 1906 which is newly proposed in the present case. In an example 1913, a BSL ID is “BSL00004”, a BSL name is “credit research evaluation”, a service ID is “SV00004”, and a node ID is “ND00004”, thus indicating that the BSL information is to evaluate a research company D which provides a credit research service.

It should be noted that the definition which includes data of such evaluation items and evaluation values is just an example, and the definition may include other information.

In addition, the SLA data 1905 comprises an evaluation item 1907, an evaluation value 1908, and a meaning 1909 which describes the evaluation 1907 by using a free format. In the example 1914, the evaluation item is “availability”, the evaluation value is “95%”, and the meaning is “availability monitored by months=(one month−downtime)/one month.”

The BSL data 1906 comprises an evaluation item 1910, an evaluation value 1911, and a meaning 1912 which describes the evaluation item 1910 by using a free format. More specifically, the BSL data 1906 comprises an example 1915A, an example 1915B, and an example 1915C. In the example 1915A, the evaluation item is “research quickness”, the evaluation value is “3 days”, and the meaning is “days to give answer for research results”; in the example 1915B, the e valuation item is “research area”, the evaluation value is “Kanto”, and the meaning is “Researchable area of research company”; and in the example 1915C, the evaluation item is “research cost”, the evaluation value is “¥10,000”, the meaning is “average research cost per research.” In addition, for other evaluation items than stated above, a “researchable business field”, “company size”, “research achievements”, or the like, may be included, for example. Further, for a financing examination service, such evaluation items as “assessment quickness”, “preferred range of interest”, “severity of assessment”, “quickness of request for decision”, etc. may be conceived.

Next, the access authority grant screen 800 will be described.

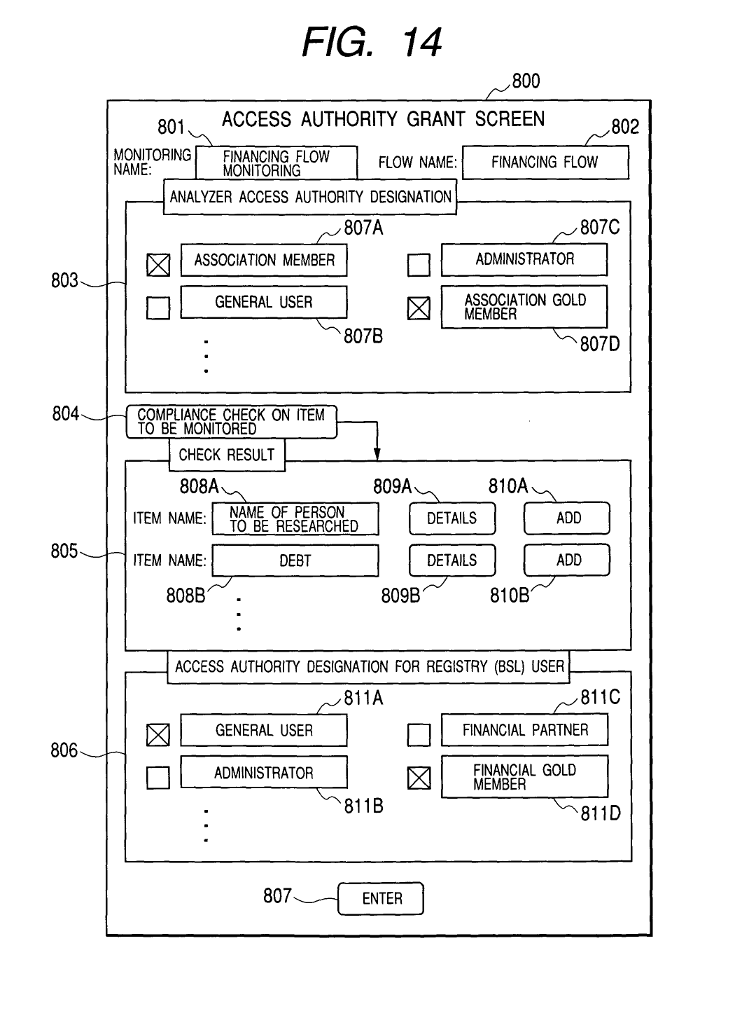

As shown in FIG. 14, the access restriction grant screen 800 comprises a label 801 which displays monitoring name, a label 802 which displays the flow name to be monitored, an “enter” button 807 to notify analyzer security information 306 and the access control 131 of information concerning access authority, a window 803 which designates the access authority of an analyzer, a “compliance check on item to be monitored” button 804 to check the compliance as to whether the item to be monitored here does not infringe the monitoring item that has been given to each access authority in advance, a window 805 which displays the result of compliance check, and a window 806 to specify the access authority of a registry user (the service user 100 or the manager 120). In the example, the monitoring name is “financing flow monitoring”, and the flow name is “financing flow.”

The window 803 indicates access authority 2004 of the analyzer security information 306 names almost as it is, and comprises labels 807A, 807B, 807C and 807D which respectively display access authority names. When respective check boxes provided next to the label names 807A, 807B, 807C and 807D are ticked, it is possible to allow referring to items (an item designated by the monitoring message designation screen 500 or the monitoring history designation screen 600) that are to be newly monitored here by the monitoring name concerned for each authority. In the example, since the respective check boxes for the label 807A and the label 807D have been ticked among those for access authority labels “Association Member”, “Administrator”, “General User” and “Association Gold Member”, the item to be monitored will be transmitted here to the BSL analyzer 134 which has the “Association Member” authority or the “Association Gold Member” label name.

The button 804 is used in such a way that each access authority which permitted reference to monitoring items in the window 803 checks whether such items other than those originally permitted in permission items 2005 of the analyzer security information 306 are not included in the items that have been permitted to be newly monitored here. If any items other than those permitted in the permission items are found to be included, such items will be displayed in the window 805.

The window 805 displays the result of checking operations implemented by the button 804. The window 805 comprises item name labels 808A and 808B, buttons 809A and 809B which respectively display detailed information of the item names, and buttons 810A and 810B which adds respective items to the permission items 2005 anew. Among these items, for those that are judged not to be added to the permission items 2005, a request for reviewing monitoring items will be sent to the BSL analyzer 134. In the example, the “name of person to be researched” and the “debt” are items that are not originally available in the permission items 2005.

The window 806 indicates access authority 2106 of the user security information 323 names almost as it is, and when respective check boxes provided next to the labels 811A, 811B, 811C and 811D are ticked, it is now possible to allow reference to items that are to be monitored anew here by the monitoring name concerned and the BSL information 137 that is to be derived here anew by the BSL analyzer 134 for each authority. In the example, since the respective check boxes for the label 811A and the label 811D have been ticked among those for access restriction labels “General User”, “Financial Partner”, “Administrator” and “Financial Gold Member”, the reference to new BSL information 137 will be permitted this time to the service user 100 or the manager 120 who have the authority “General User” or “Financial Gold Member” label. It should be noted that information permitted in the window 806 will be reflected in a permission item 2107 for the appropriate access authority 106.

Note that respective interface components shown in FIG. 14 only exemplify an example to realize the access authority grant screen 800. Alternatively, the label arrangement may be changed, or the window may be so structured that, by displaying a tier structure in the left pane, and, likewise, detailed information of respective items in the right pane. In either case, what is necessary is to enable handling of information similar to input and output information described here.

Next, the analyzer security information 306 will be described.

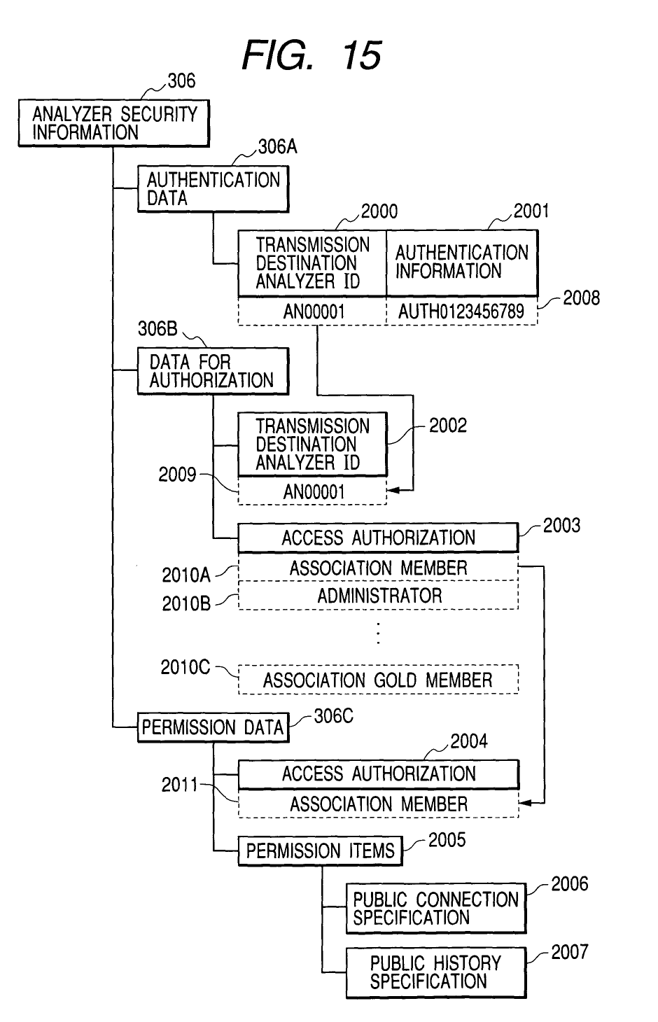

As shown in FIG. 15, the analyzer security information 306 comprises a plurality of authentication information 306A, a plurality of authorization information 306B and a plurality of permission data 306C.

The authentication data 306A is data which enables the BSI collector 113 to authorize the BSL analyzer 134, and the data comprises a transmission destination analyzer ID 2000 which corresponds to a generally used user ID and authorization information 2001 which corresponds to a password. In an example 2008, the transmission destination analyzer ID is “AN00001”, and the authorization information is “AUTH0123456789.” The authorization information may alternatively be complicate binary data such as an SSL authorization certificate. In addition, the mechanism of authorization processing itself may originally be further complicate algorithms such as an SSL, RSA and DES.

Next, the authorization data 306B is data to define what access authorities the BSL analyzer 134 has, and the data comprises a transmission destination analyzer 2002 and a plurality of access authorities 2003. The authorization data 306B and the authentication data 306A are associated with each other by use of the transmission destination analyzer ID 2002 and the transmission destination analyzer ID 2000. In an example 2009, the transmission destination analyzer ID is “AN00001” which is the same as that for the example 2008, and in examples 2010A, 2010B and 2010C for the access authority 2003, the authorities of “Association Member”, “Administrator” and “Association Gold Member” are granted.

Likewise, the permission data 306C is information to define what data (the service definition 136 in the registry 135) is to be respectively disclosed to the access authority 2003 that is indicated in the authorization data 306B, and the data comprises an access authority 2004 and a plurality of permission items 2005. The permission data 306C and the authorization data 306B are associated with each other by use of the access authority 2004 and the access authority 2003. In an example 2011, the access authority is “Association Member” which is the same as that of the example 2010A.

In addition, the permission items 2005 further comprise a plurality of public connection specification 2006 and a plurality of public history specification. The structure of the public connection specification 2006 is the same as that of the connection specification 136A, but the specification 2006 only stores data wherein an access is permitted to each access authority. Likewise, the structure of the public history specification 2007 is the same as that of the history specification 136B, but the specification 2007 only stores data wherein an access is permitted to each access authority.

Finally, the user security information 323 will be described.

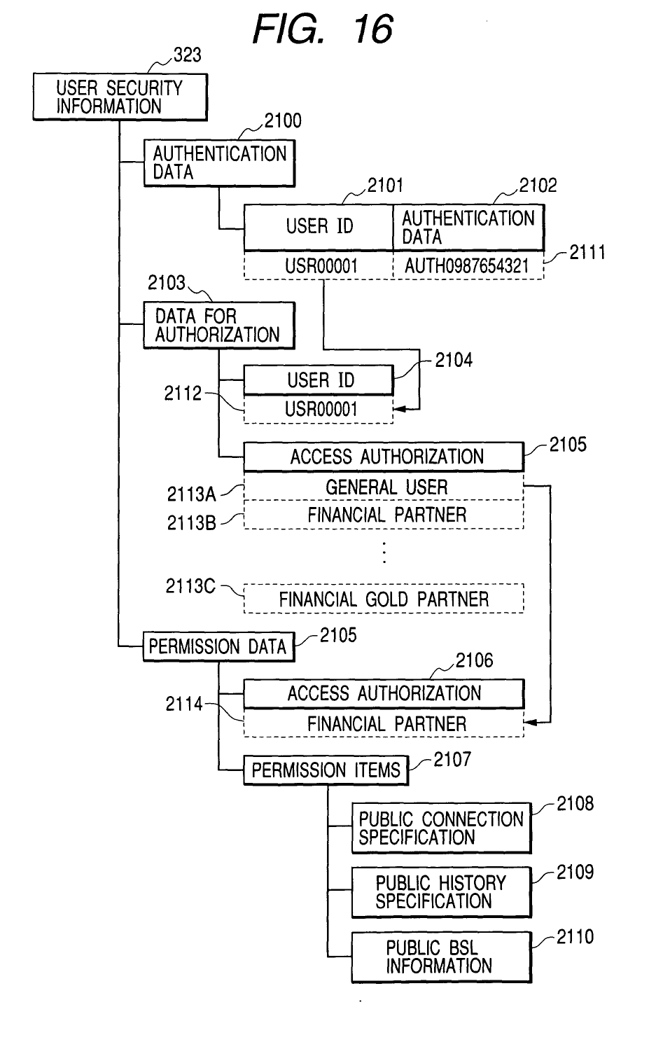

As shown in FIG. 16, the user security information 323 has almost the same structure as that of the analyzer security information 306, and the information contains a plurality of authentication data 2100, a plurality of data for authorization 2103, and a plurality of permission data 2105. The user security information 323 is different from the analyzer security 306 in that the transmission analyzer ID 2000 is User ID 2101, the transmission analyzer ID 2002 is User ID 2104, public BSL information 2110 is added to the permission item 2107, and examples.

Hereinafter, a description will mainly be made of examples.

The authorization data 2100 is data with which the access control 131 authenticates the service user 100 or the manager 120, and the data contains a user ID 2101 and authentication information 2102. In an example 2111, the user ID is “USR00001” and the authentication information is “AUTH0987654321.”

Next, the data for authorization 2103 is data to define what access authorities the service user 100 or the manager 120 has, and the data contains a user ID 2104 and a plurality of access authorities 2105. The data for authorization 2103 and the authentication data 2100 are associated with each other by use of the user ID 2101 and the user ID 2104. In an example 2112, the user ID is “USR00001” which is the same as that of the example 2111, and authorities “General User”, “Financial Partner” and “Financial Gold Partner” are granted for the ID in examples 2113A, 2113B and 2113C of the access authority 2105.

Likewise, the permission data 2105 is information to define what data (the service definition 136 and the BSL information 137 in the registry 135) is to be disclosed respectively to the access authorities 2105 shown in the data for authorization 2103, and the data contains an access authority 2106 and a plurality of permission items 2107. The permission data 2105 and the data for authorization 2103 are associated with each other by use of the access authority 2106 and the access authorities 2105. In an example 2114, the access authority is “Financial Partner” which is the same as that of the example 2113B.

In addition, the permission item 2107 comprises a plurality of public connection specifications 2108, a plurality of public history specifications 2109, and a plurality of public BSL information 2110. The structure of the public connection specification 2108 is the same as that of the connection specification 136A, but the specification 2108 only stores data wherein an access is permitted to each access authority. Likewise, the structure of the public BSL specification 2110 is the same as that of the BSL information 137, but the specification 2110 only stores data wherein an access is permitted to each access authority.

Next, the following will be performed in the “BSI collection phase.”

As shown in FIG. 4, in the BSI collector 113A in which a monitoring item has been determined, whenever the SP 110A executes sending and reception of a message to be monitored, the message acquisition function 307 traps the message between the service A 111A and communication processing 308 which executes the message transmission, and notify the history acquisition function 300 of the generation of the message to be monitored. The history acquisition function 300 traps a history associated with the message to be monitored from the history 112A. The message and the history thus trapped are notified to the processor for picking up of items to be monitored 303, and the item to be monitored will be picked up. Next, determination of the BSL analyzer 134 to which the picked-up items are transmitted, and check whether or not such items can be transmitted, by referring to the analyzer security information, to an appropriate BSL analyzer 134 are executed in the processor for security check 304. Then, BSI is set to respective transmission items, and the encryption processing and the transmission processing to the BSL analyzer 134 are executed in the processor for BSI encryption/transmission 305.

Note that the encryption processing is not mandatory. There could be a BSL analyzer 134 which is originally not ready for encryption.

Next, the following will be performed in the “BSL analysis phase.”

As shown in FIG. 4, the BSL analyzer 134 decrypts the received BSI in the processor for BSI reception/decryption 310. The processing will be repeated until all BSIs configuring a transaction are collected. Next, the received BSIs are put together according to each transaction and are stored as BSI information for the entire flow (an aggregation of transaction units 311 processor). The processing will be repeated until BSIs configuring a business task are collected. Thereafter, if the business task is composed of a plurality of transactions, the BSI information is put together according to a business task and is stored as BSI information for the entire business task (processor for an aggregation of business units 312). Lastly, the BSI is analyzed to make the BSI information which is stored in the registry 135. The above-stated processing will be repeated on regular basis to keep the BSL information 137 always updated.

Note that the decryption processing is not mandatory. There could be a message that is not encrypted. Further, for the aggregation processing, various methods are possible, ranging from a method for simply calculating an average value or dispersion to a method for executing more complicated statistical work to calculate a risk evaluation value. Processing methods are not particular issues here. However, processing to derive the BSL information 137 will be introduced from time to time. Alternatively, it may be so arranged that a calculating method for evaluating data is defined according to data contained in the BSI information, an evaluation result is obtained based on the defined calculating method, and the evaluation result thus obtained is output to a screen, a file, a storage device, etc., or it may be arranged in other ways.

By taking the arrangement as stated in the above, it is possible to aggregate items to be monitored that are collected by respective BSI collectors into a section in the BSL analyzer 134.

Next, the following will be performed in the “change flow phase.”

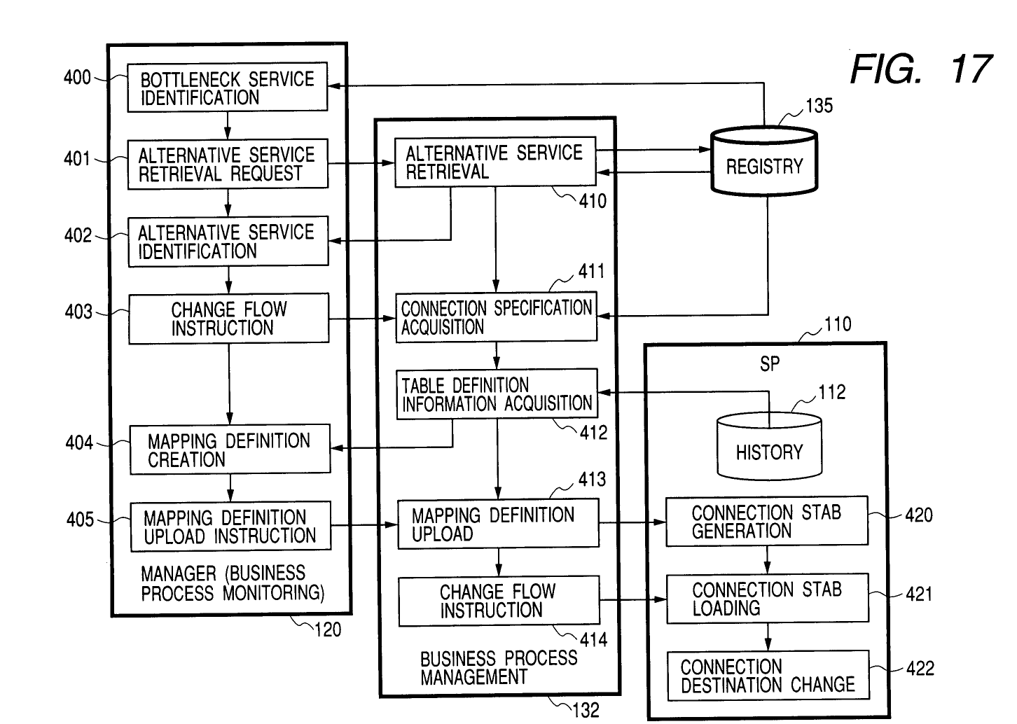

As shown in FIG. 17, the manager 120 first acquires evaluation information on an existing flow from the registry 135 through the flow screen 900 (to be described later) and identifies a service or a node that constitutes a bottleneck (hereinafter simply referred to as a bottleneck) based on information available in an evaluation information display screen 100 (to be described later) (processing for a bottleneck service identification 400).

It should be noted that the processing to identify a region that constitutes a bottleneck may be so arranged that an evaluation value is displayed on a screen, a region that constitutes a bottleneck is designated by a user based on the evaluation value displayed on the screen, and information designated by the user is accepted by a program. Also, the processing may be so arranged that evaluation values of services provided by a plurality of service providers is compared, and a service with lower evaluation value is identified as a bottleneck, as a result of such comparison. Further, the processing may be so arranged that information that constitutes a threshold value for an evaluation value is defined in advance for each service item, and a service provider, etc. which provides a service representing a lower value than the threshold value thus defined is judged to be a bottleneck, or it may be arranged in other ways.

Next, retrieval of another service or a flow replacing the bottleneck, with the BSL information 137, the service definition 136 and a flow definition 138 (to be described later) being conditions for retrieval, is requested to the business process management 132 via a serve/flow retrieval screen 1100 (to be described later) (processing for an alternative service retrieval request 401).

It should be noted that the above-stated processing may be so arranged that an entry of an identifier, data, etc. showing a bottleneck, such as an identified service name and a node name from a user is accepted, and the accepted data, etc. are transmitted to the business process management 132, data obtained as a result of bottleneck evaluation being performed by a program is transmitted, or the processing may also be executed in other ways.

Next, the business process management 132 refers to the registry for a service or a flow which conforms to retrieval conditions (processing for an alternative service retrieval 410), and returns the BSL information 137, the service definition 138 and the flow definition 136 to the manager 120.

Thereafter, the manager 120 selects a service or a flow (hereinafter simply referred to as the alternative service) which substitutes the bottleneck based on the retrieval result displayed on a retrieval result display screen 1200 (to be described later) (processing for an alternative service identification 402).

It should be noted that an entry of information, from a user, designating an alternative service may be accepted. Further, a program may select a service provider which provides a service with a higher evaluation value than that of the bottleneck item may be selected for an alternative service, or any other methods may be adopted.

Next, a change of the bottleneck to an alternative service is notified to the business process management 132 (processing of a change flow instruction 403).

Next, from the registry 135, the business process management 132 acquires the connection information 136A from the registry 135 to the alternative service and the connection information 136B to a service which has been a server of the bottleneck (processing for a connection specification acquisition 411). Then, from the history 112, the business process management 132 acquires a node history definition 2400 (to be described later) of a service which has been a client of the bottleneck (hereinafter simply referred to as the client service) and a service which has been a server of the bottleneck (hereinafter simply referred to as the server service) (processing for table definition information acquisition 412). Finally the business process management 132 sends the information back to the manager 120.

Next, based on the information acquired from the business process management 132, the manager 120 creates a mapping definition 2800 (to be described later) for changing connection to the alternative service via a mapping definition creation screen 1300 (to be described later) (process for mapping definition creation 404). Thereafter, the manager 120 uploads the mapping definition 2800 thus created to the business process management 132 (processing for mapping definition upload instruction 405).

Next, the business process management 132 uploads the mapping definition 2800 received from the manager 120 to each SP 110 which provides the appropriate alternative service, the client service and the server service (processing for mapping definition upload 4113), and then performs a change flow instruction 414 simultaneously to each SP 110.

Finally, each SP 110 generates a connection stab based on the mapping definition 2800 received from the business process management 132 (processing for a connection stab generation 420). Thereafter, upon receiving the change flow instruction from the business process management 132, each SP 110 blocks its own service being provided, dynamically loads the connection stab (with the program booted) (processing for connection stab loading 421) and performs a connection destination change 422.

It should be noted that the processing for mapping definition upload 413 and the processing for change flow instruction 414 may be executed simultaneously. Further, the processing for the connection stab creation 420 and the processing for the connection stab loading 421 may be executed simultaneously. Furthermore, following a change in flow, generation of a program required for a connection to a service provider after the change or processing required for booting a program may be executed.

Such arrangement enables the manager 120 to change a flow by quickly finding out a bottleneck in a flow and further by easily retrieving an alternative service or flow. In addition, only by designating affects of such change flow at a section of the BSL analyzer 134, the manager can notify each SP of items for taking necessary measures.

It should be noted that a program may automatically execute processing to judge bottleneck components of a flow and change such bottleneck components, the program may be so arranged to accept an entry instruction from a user and execute processing according to the instruction received, or the program may be arranged in other ways. Further, in a business flow, setting of a node (including a program to process a service of a service provider or a service to be provided by a service provider) after changing the flow, a connection program that will be necessary to send and receive various data or the like may be executed automatically, or other methods may be employed.

First, the flow screen 900 will be described.

As shown in FIG. 2, the flow screen 900 includes squares with round corner representing services (903, 904, 905, 906, 907, 908, 909, 910, 911 and 912), squares representing enterprise boundaries (901 and 902), and a pop-up menu 913. It should be noted that a square representing a node boundary is omitted if the service boundary and the enterprise boundary are the same. Further, a name shown in a service implies a service name, and a name in parenthesis in a service implies a node name.

A plurality of services are coupled to each other to form a flow. A coupling shown as a solid line is a flow before changing the flow, and a coupling shown as a dotted line is a flow after changing the flow by the manager 120. It should be noted that the description on flows before and after change will be omitted here since the flows have been described earlier.

In the example of the flow screen 900, services and enterprises which constitute the flow include the service user 901, the bank 902, the financing service (banking office counter) 903, the accounting section (account management company A) 904, the financing examination (examination company B) 905, the credit research (credit research company D) 906, the debt collection (debt management) 907, the credit research (credit research company C) 908, the research information collection (information collection company E) 909, the credit risk evaluation (evaluation company F) 910, the large customer debt collection (large debt management) 911, and the small customer debt collection (debt management company G) 912.

Further, the pop-up menu 913 is displayed by operating the mouse on each service and includes the following two menus. First, the menu of the evaluation information display 913A initiates the evaluation information display screen 1000 which is used to display evaluation information of a node that provides an appropriate service. Second, the menu of the alternative service retrieval 913 initiates the service/flow retrieval screen 1100 which is used to retrieve an alternative service or flow of the appropriate service.

Note that all the interface components shown in FIG. 2 only exemplify an example to realize the flow screen 900. Alternatively, the label arrangement may be changed, or the window may be so structured that, by displaying a tier structure in the left pane, and, likewise, detailed information of respective items in the right pane. In either case, what is necessary is to enable handling of information similar to input and output information described here.

Next, the evaluation information display screen 1000 will be described.

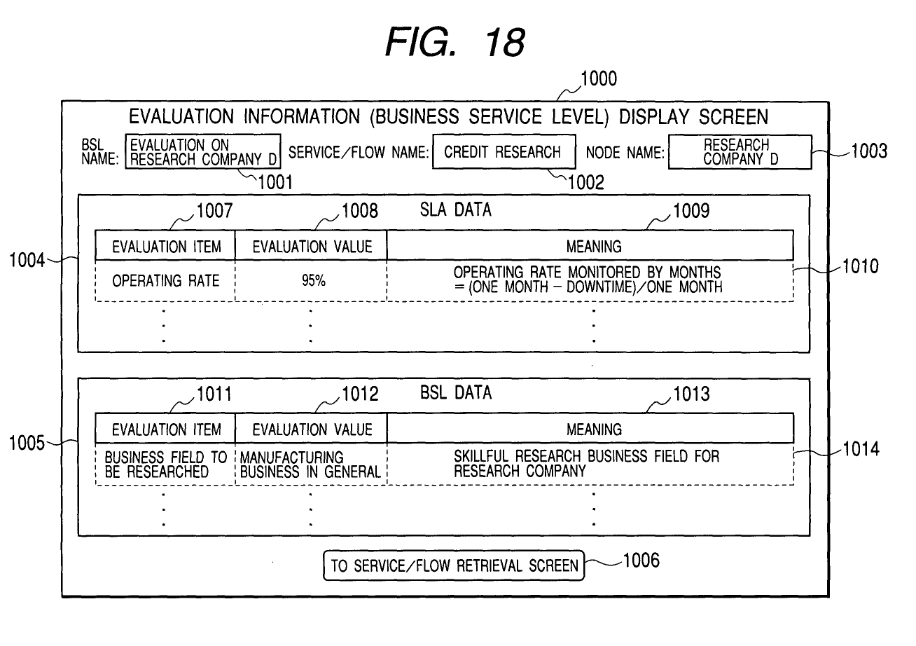

As shown in FIG. 18, the evaluation information display screen 1000 includes a label 1001 which displays a BSL name, a label 1002 which displays a service name or a flow name, a label 1003 which displays a node name, a “To service/flow retrieval screen” button 1006 used to shift the current screen to the service/flow retrieval screen 1100, a window 1004 for displaying SLA data, and a window 1005 for displaying BSL data. In the example, the label 1001 is “evaluation on research company D”, the label 1002 is “credit research”, and the label 1003 is “research company D.”

The SLA data window 1004 comprises a plurality of records comprising an evaluation item 1007, an evaluation value 1008 and a meaning 1009 which describes the evaluation item 1007 by using a free format, and information, among appropriate SLA data 1905, to which reference is permitted is displayed almost as it is. In an example 1010, the evaluation item is “availability”, the evaluation value is “95%”, and the meaning is “availability monitored by months=(one month−downtime)/one month.”

The BSL data window 1005 comprises a plurality of records comprising an evaluation item 1011, an evaluation value 1012, and a meaning 1013 which describes the evaluation item loll by using a free format, and information, among appropriate BSL data 1906, to which reference is permitted is displayed almost as it is. In an example 1014, the evaluation item is “research business field”, the evaluation value is “manufacturing business in general”, and the meaning is “skillful research business field for research company.”

Note that all the interface components shown in FIG. 18 only exemplify an example to realize the evaluation information display screen 1000. Alternatively, the label arrangement may be changed, or the window may be so structured that, by displaying a tier structure in the left pane, and, likewise, detailed information of respective items in the right pane. In either case, what is necessary is to enable handling of information similar to input and output information described here.

Next, the service/flow retrieval screen 1100 will be described.

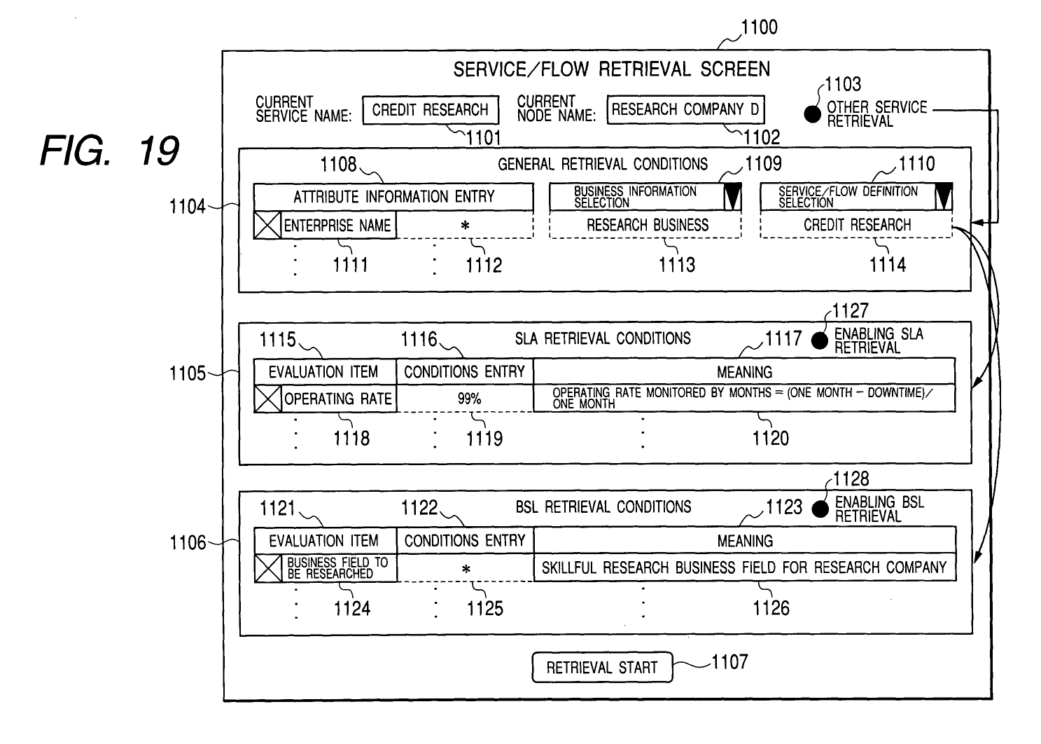

As shown in FIG. 19, the service/flow retrieval screen 1100 includes a label 1101 which displays a service name currently in use, a label 1102 which displays a node name currently in use, a radio button 1103 which is used to show whether services other than the service currently in use will be retrieved or not, a “retrieval start” button 1107 for starting retrieval, a window 1104 for entering general retrieval conditions, a window 1105 for entering SLA retrieval conditions, and a window 1106 for entering BSL retrieval conditions.

It should be noted that a click on the “retrieval start” button 1107 will shift the current screen to a retrieval result display screen 1200. In the example, the label 1101 is “credit research”, and the label 1102 is “research company D.” The “other service retrieval” radio button 1103 is ticked to allow retrieval of other services. When the radio button 1103 is ticked, the general retrieval condition window will be activated (enabled for entry).

The general retrieval conditions window 1104 includes an attribute information entry box 1108 which is used to designate attributes of enterprise such as an enterprise name and contact address as retrieval conditions, a business information selection list 1109 which is used to designate business tasks of enterprise such as a business type and a service provided as retrieval conditions, and a service/flow definition selection list 1110 which is used to designate what service definitions or flow definitions are supported as retrieval conditions. In the example, an enterprise name box 1111 is ticked in the attribute information entry boxes 1108 and “*” is designated for an entry value 1112. This means that any enterprise name will be retrieved.

In addition, in the business information selection list 1109, since a research business 1113 has been selected, an enterprise which provides a service business will be retrieved. Further, in the service/flow definition selection list 1110, since a credit research 1114 has been selected, an enterprise which supports a connection that uses a service definition of credit research service will be retrieved. In addition, by selecting the credit research 1114, conditions associated with respective credit research services are displayed respectively in an SLA retrieval condition screen and a BSL retrieval condition window 1106. It should be noted that the information designated in the general retrieval condition window 1104 is cross-checked with general information in the registry 135 when making retrieval. Also note that the structure of general information is self-explanatory and thus the description will be omitted here.

The SLA retrieval conditions window 1105 includes a plurality of records comprising an evaluation item list 1115 which displays item names to be retrieved, a condition entry box 1116 which is used to enter retrieval conditions, and a meaning 1117 which describes the evaluation item 1115 by using a free format.

In the example, since availability box 1118 is ticked for an item in the evaluation item list 1115, and “99%” is designated as an entry value 1119, enterprises which commit the availability of 99% or over will be retrieved. In addition, a description “availability monitored by months=(one month−downtime)/one month” is displayed in the meaning 1120. It should be noted that the information designated in the SLA retrieval condition window 1105 is cross-checked with the SLA data 1905 in the BSL information 137 contained in the registry 135 when making retrieval.

The BSL retrieval condition window 1106 includes a plurality of records comprising an evaluation item list 1121 which displays item names to be retrieved, a conditions entry box 1122 which is used to enter retrieval conditions, and a meaning 1123 which describes the evaluation item 1121 by using a free format. In the example, since a research business field 1124 is ticked for an item in the evaluation item list 1121, and “*” is designated as an entry value 1125, enterprises will be retrieved without specifying any business field. In addition, a description “skillful research business field for research company” is displayed in the meaning 1126. It should be noted that the information designated in the BSL retrieval condition window 1106 is cross-checked with the BSL data 1906 in the BSL information 137 contained in the registry 135 when making retrieval.

Note that all the interface components shown in FIG. 19 only exemplify an example to realize the service/flow definition selection 1110. Alternatively, the label arrangement may be changed, or the-window may be so structured that, by displaying a tier structure in the left pane, and, likewise, detailed information of respective items in the right pane. In either case, what is necessary is to enable handling of information similar to input and output information described here.

Next, the flow definition 138 will be described.

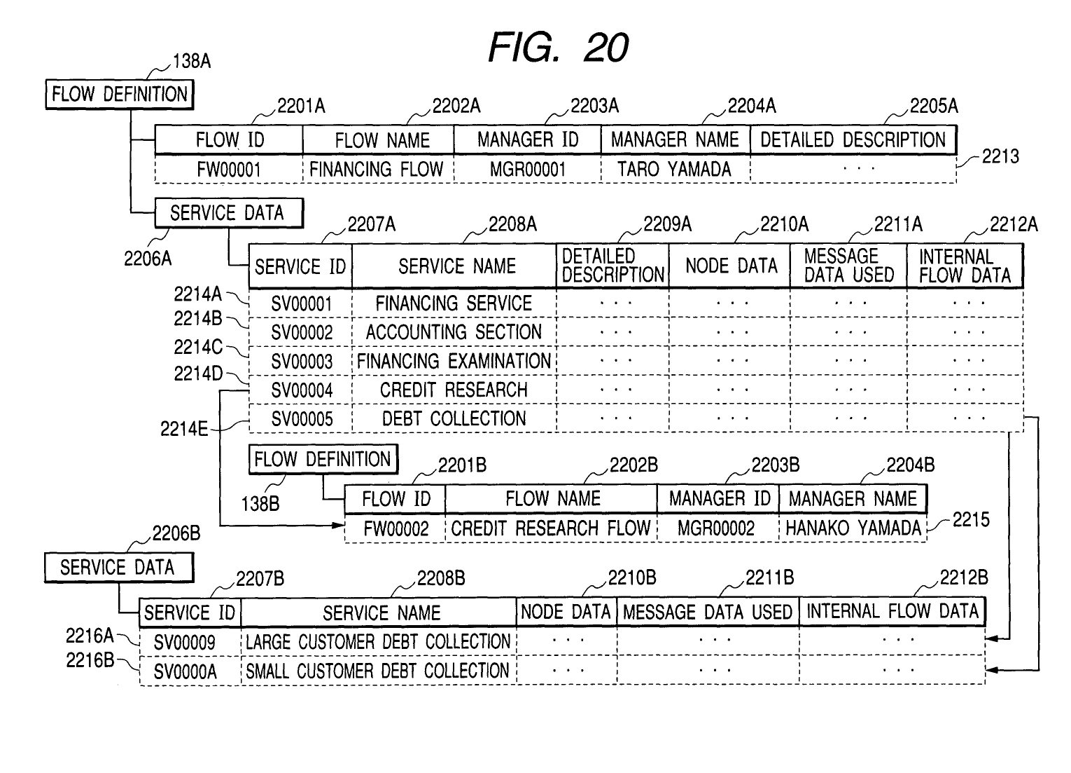

As shown in FIG. 20, the flow definition 138 contains a flow ID 2201A, a flow name 2202A, a manager ID 2203 who owns an appropriate flow, a manger name 2204A, a detailed description 2205A of the flow name 2202A by using a free format, and a plurality of service data 2206A (to be described later). An example 2213 illustrates a financing flow displayed on the flow screen 900, wherein the flow ID is “FW00001”, the flow name is “financing flow”, the manager ID showing the manager 120 is “MGR0001”, and the manager name is “Taro YAMADA.”

The financing flow comprises a plurality of services, and information on such plurality of services is displayed in service data 2214A, 2214B, 2214C, 2214D and 2214E. Reference symbol 2214A indicates the financing service 903, wherein the service ID is “SV00001” and the service name is “financing service.” The reference symbol 2214B indicates the accounting section 904, wherein the service ID is “SV00002” and the service name is “accounting section.” The reference symbol 2214C indicates the financing examination 905, wherein the service ID is “SV00003” and the service name is “financing examination.” The reference symbol 2214D indicates the credit research 906, wherein the service ID is “SV00004” and the service name is “credit research.” The reference symbol 2214E indicates the debt collection 907, wherein the service ID is “SV00005” and the service name is “debt collection.”

When the manager 120 is to change a credit research service provided by the credit research company D 906 to a credit research flow 2215 provided by the credit research company C 908, the service 2214D can simply be changed to the flow 2215. It should be noted that the structure of the flow 2215 is similar to that of the flow definition 138B and is the same as that of the flow definition 138A. In the flow 2215, a flow ID 2201B is “FW00002”, a flow name 2202B is “credit research flow”, a manager ID 2203B is “MGR00002”, and a manager name 2204B is “Hanako YAMADA.”

Further, when the manager 120 is to divide a debt collection service provided by the credit management 907 into a small customer debt collection service 2216A provided by the debt management company G 912 and a large customer debt collection service 2216B provided by the large debt management 911, such division can simply be executed by creating the mapping definition 2800 in the manner that the service 2216A and the service 2216B are added to the service 2214E, and then if the service is the small customer debt collection, the processing is requested to the service 2216A, or if the service is the large customer debt collection, the processing is requested to the service 2216B.

It should be noted that the structure of the service 2216A and the service 2216B is similar to that of the service data 2206B and is totally the same as that of the service data 2206A. In the service 2216A, the service ID is “SW00009”, the flow name is “large customer debt collection”, and in the service 2216B, the service ID is “SV0000A”, and the service name is “small customer debt collection.”

Next, the service data 2206A will be described.

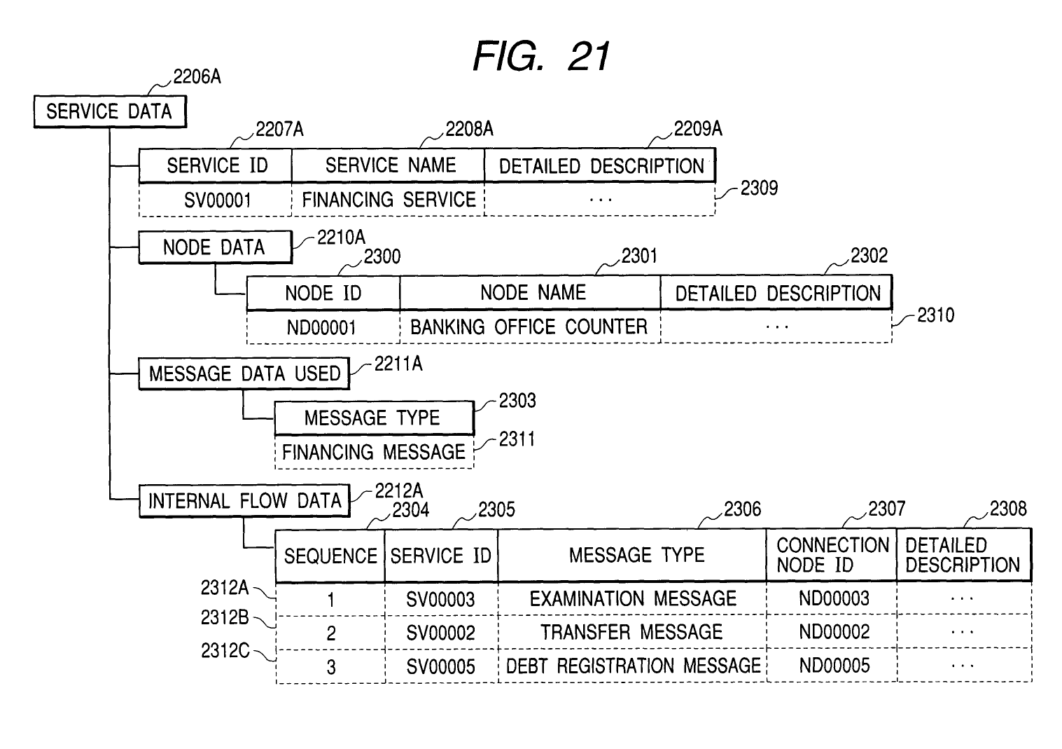

As shown in FIG. 21, the service data 2206A includes a service ID 2207A, a service name 2208A, a detailed description 2209A of the service name 2208A by using a free format, node data 2210A, use message data 2211A which is used at the time of incorporating an appropriate service in the flow definition 138A, and a plurality of internal flow data 2212A that are formed to realize the appropriate service and are formed internally. In an example 2309, the service ID is “SV00001” and the service name is “financing service.”

The node data 2210A further-includes a node ID 2300, a node name 2301, and a detailed description 2302 of the node name 2301 by using a free format. An example 2310 indicates the financing service 903, wherein the node ID is “ND00001” and the node name is “banking office counter.”

The reality of the use message data 2211A is a message type 2303, and in an example 2311, the message type is “financing message.”

In addition, the internal flow 2212A further includes a call node sequence 2304, a service ID 2305, a message type 2306 to be used, a connection node ID 2307 which shows a connection destination, and a detailed description 2308 of each record by using a free format. The example represents three records 2312A, 2312B and 2312C. An example 2312A shows that the financing examination 905 is to be used, wherein the sequence is “1”, the service ID is “SV00001”, the message type is “examination message”, and the connection node ID is “ND00003.”

Further, an example 2312B shows that the accounting section 904 is to be used, wherein the sequence is “2”, the service ID is “SV00002”, the message type is “transfer message”, and the connection node ID is “ND00002.”

Furthermore, an example 2312C shows that the debt collection 907 is to be used, wherein the sequence is “3”, the service ID is “SV00005”, the message type is “debt registration message”, and the connection ID is “ND00005.”

Next, the retrieval result display screen 1200 will be described.

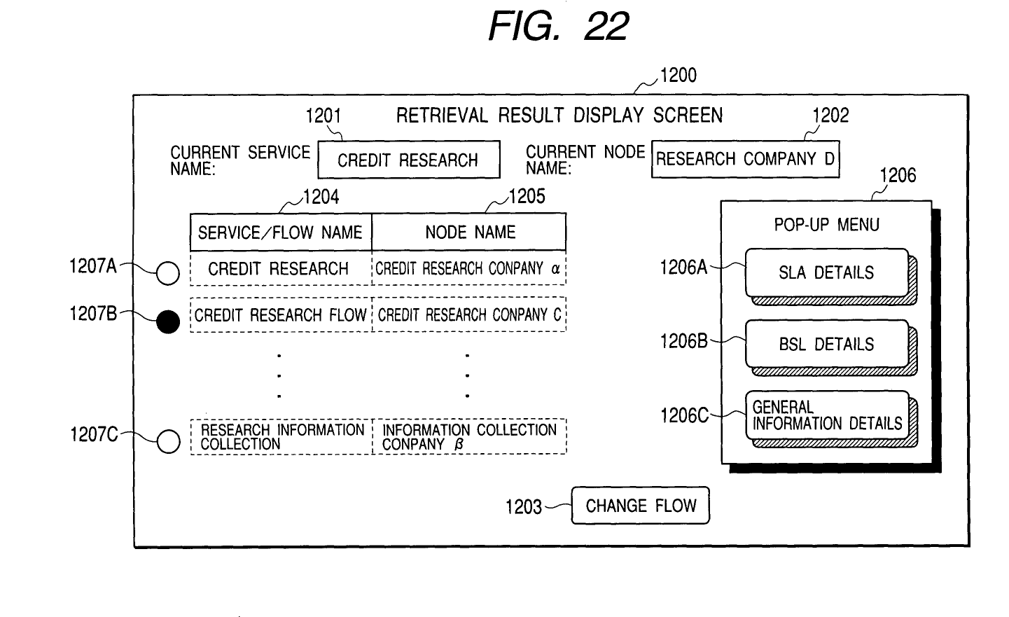

As shown in FIG. 22, the retrieval result display screen 1200 includes a plurality of records comprising a label 1201 which displays a currently-used service name, a label 1202 which displays currently-used node name, a “change flow” button 1203 which shifts the current screen to the mapping definition creation screen 1300, a label 1204 which is used to display service names or flow names that are hit during a retrieval and a label 1205 which is used to display node names that are hit during a retrieval, and a pop-up menu 1206. In an example, the current service name 1201 is “credit research” and the current node name 1202 is “research company D.”

Further, examples for the service/flow name label 1204 and the node name 1205 each comprises examples 1207A, 1207B and 1207C, wherein the service/flow name for the example 1207A is “credit research” and the node name is “credit research company α”, the service/flow name for the example 1207B is “credit research flow” and the node name is “credit research company C”, the service/flow name for the example 1207C is “research information collection” and the node name is “information collection company β”, respectively.

Further, the pop-up menu 1206 is displayed by operating the mouse on each record (a pair of records comprising the service/flow name 1204 and the node name 1205) and includes the following three menus. First, when an SLA detail menu 1206A is selected, such data to which reference has been permitted among the SLA data 1905 of an appropriate node will be displayed. Second, when a BSL detail menu 1206B is selected, such data to which reference has been permitted among the BSL data 1906 of an appropriate node will be displayed. Finally, when a general information detail menu 1206C is selected, such data to which reference has been permitted among the general information (attribute information or business type information that is stored in the registry 135) of an appropriate node will be displayed.

Note that all the interface components shown in FIG. 22 only exemplify an example to realize the retrieval result display screen 1200. Alternatively, the label arrangement may be changed, or the window may be so structured that, by displaying a tier structure in the left pane, and, likewise, detailed information of respective items in the right pane. In either case, what is necessary is to enable handling of information similar to input and output information described here.

Next, the node history definition 2400 will be described.

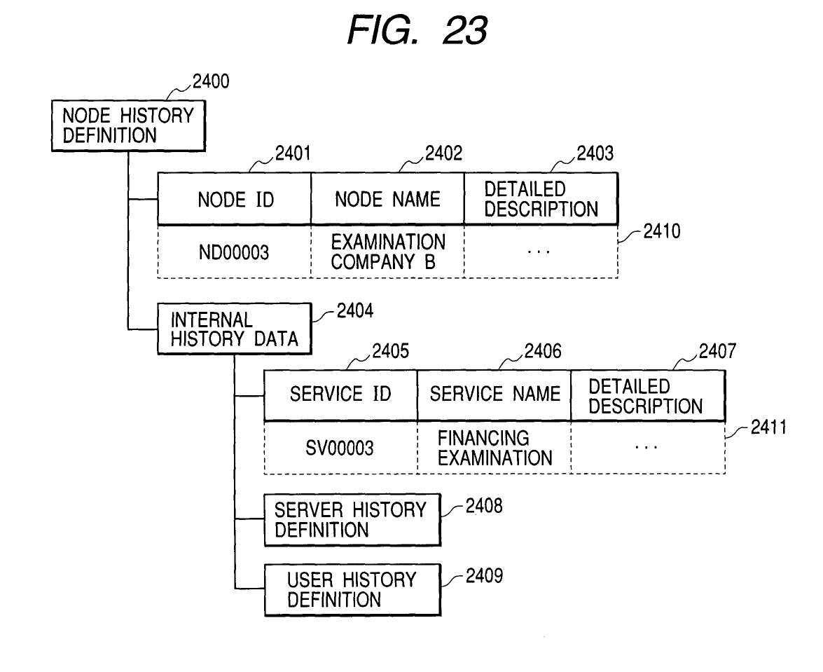

As shown in FIG. 23, the node history definition 2400 includes a node ID 2401, a node name 2402, a detailed description 2403 of the node name 2402 by using a free format, and a plurality of internal history data 2404. In an example 2410, the node ID is “ND00003” and the node name is “examination company D.”

The internal history data 2404 includes a service ID 2405, a service name 2406, a detailed description 2407 of the service name 2406 by using a free format, a server history definition 2407, and a client history definition 2408. In an example 2411, the service ID is “SV00003” and the service name is “financing examination.” It should be noted that the structure of the server history definition 2408 is totally the same as that of the server history specification 1405. In addition, the structure of a client history definition 2409 is totally the same as that of the client history specification 1406. Since the internal history data 2404 also allows an access only to items that have been permitted to refer to, it is a prerequisite that the manager 120 has a powerful access authority (e.g., administrator) for appropriate internal history data 2404 when creating the mapping definition 2800.

Next, the mapping definition creation screen 1300 will be described.

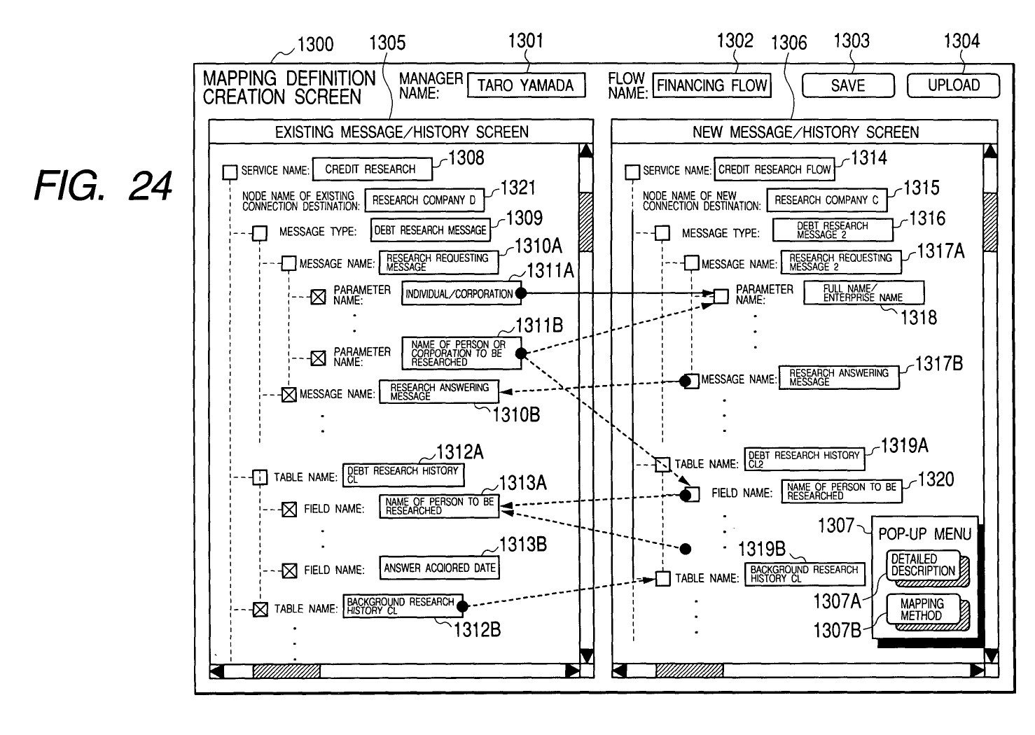

As shown in FIG. 24, the mapping definition creation screen 1300 includes a label 1301 which displays the manager name, a label 1302 which displays the flow name, a “save” button 1303 which is used to save the mapping definition 2800, an “upload” button 1304 which is used to upload the mapping definition 2800 (to be described later) to each SP, an “existing message/history screen” window 1305 which is used to display an existing message and existing history information in a mapping source, and a “new message/history screen” window 1306 which is used to display a new message and new history information in a mapping destination. In the example, the manager name label 1301 is “Taro YAMADA” and the flow name label 1302 is “financing flow.”

The existing message/history screen window 1305 indicates the structure of the service definition 136 almost as it is. The window 1305 also comprises a label 1321 which displays a node name of existing connection destination and a label 1308 which displays a plurality of service names come on top of other labels, and message information and history information are displayed under the layer of each service. The message information displays the structure of the connection specification 136A almost as it is and comprises a label 1309 which displays a plurality of message types constituting a service, labels 1310A and 1310B which respectively display a plurality of message names constituting each message type, and labels 1311A and 1311B which respectively display a plurality of parameter names constituting each message name.

Further, the history information displays the server history specification 1405 and the client history specification 1406 almost as they are, and the information comprises labels 1312A and 1312B which respectively display a plurality of table names constituting a service, labels 1313A and 1313B which respectively display a plurality of field names constituting each table name. In the example, the label 1321 is “research company D”, the label 1308 is “credit research”, the label 1309 is “debt research message”, the label 1310A is “research requesting message”, the label 1310B is “research answering message”, the label 1311A is “individual/corporation”, the label 1311B is “name of person or corporation to be researched”, the label 1312A is “debt research history CL”, the label 1312B is “background research history CL”, the label 1313A is “name of person to be researched”, and the label 1313B is “answer acquired date.”

Since the new message/history screen window 1306 also has almost the same structure as that of the window 1305 and displays the structure of the service definition 136 almost as it is, the window 1306 will be described briefly. The window 1306 comprises a label 1315 which displays a new connection destination node name, a label 1314 which displays a service name, a label 1316 which displays a message type, labels 1317A and 1317B which respectively display message names, a label 1318 which displays a parameter name, labels 1319A and 1319B which respectively display table names, and a label 1320 which displays a field name.

In the example, the label 1315 is “research company C”, the label 1314 is “credit research flow” (even if the service to be used is a flow, the flow name is displayed on the service name label for convenience”, the label 1316 is “credit research message 2”, the label 1317A is “research requesting message 2”, the label 1317B is “research answering message”, the label 1318 is “full name/enterprise name”, the label 1319A is “debt research history CL2”, the label 1319B is “background research history CL” (the table structure happens to be the same as that of the “background research history CL” 1312B), and the label 1320 is “name of person to be researched (family name).”

Among labels in the existing message/history screen window 1305, the label whose check box is ticked shows information that is used to create a new message and new history information, or is created from a new message and new history information. In the example, “individual/corporation” of the label 1311A and “name of person or corporation to be researched” of the label 1311B are mapped to “full name/enterprise name” of the label 1318. This means, for example, an existing message will be converted to a new message at the time of transmitting the message, just like “corporation”+“YAMADA” [symbol] “YAMADA Co., Ltd.” It should be noted that the mapping method can be designated by selecting a mapping method 1307B in a pop-up menu 1307. Many of the above-stated basic operators and further complicated functions are prepared as mapping operators, and if a mapping is not possible with any existing functions, it is possible to develop a new mapping function as a plug-in user program. Associations among respective items will be established through mouse operations, and once the items are associated with each other, the items will be connected with arrow-headed lines. By selecting a detailed description menu 1307A in the pop-up menu 1307, it is possible to display the detailed description of each item.

Hereinafter, other mapping examples will be described. The “name of person or corporation to be researched” of the label 1311B is also mapped to the “name of person to be researched (family name)” of the label 1320, and, for example, it is stored from an existing message to a new history at the time of sending a message, just like “Taro YAMADA” [symbol] “YAMADA.” Next, the “research answering message” of the label 1317B is mapped to the “research answering message” of the label 1310B and it is transmitted from a new received message to a current received message as it is when the reply message is received. Next, while being not shown in the “name of person to be researched (family name)” of the label 1320 and in FIG. 13, a “name of person to be researched (first name)” is also mapped to the label 1313A, and, for example, it is stored from a new history to an existing history, just like “YAMADA”+“Taro” [symbol] “Taro YAMADA.” Lastly, the “background research history CL” of the label 1312B is mapped to the “background research history CL” of the label 1319B, and information on an existing history is also copied on a new history as it is at the time of acquiring the existing history.

The mapping definition 2800 that is created as stated above is uploaded to each SP. Since the mapping definition 2800 can be created according to a manager 120, a change flow of a certain manager A will not interfere with a flow of another manager B. More specifically, even after the flow of the manager A has changed, the flow of the manager B who uses an existing flow will not subjected to change at all, thus enabling provision of a service by use of the original flow.

Further, the mapping definition 2800 contains flow information, and node information of a connection destination, as a matter of course. With such arrangement, a series of transactions will be executed via a designated connection destination node, or via a connection destination node that provides a better service one by one, based on new flow information.

Note that all the interface components shown in FIG. 24 only exemplify an example to realize the mapping definition creation screen 1300. Alternatively, the label arrangement may be changed, or the window may be so structured that, by displaying a tier structure in the left pane, and, likewise, detailed information of respective items in the right pane. In either case, what is necessary is to enable handling of information similar to input and output information described here.

With such arrangement, the manager 120 can reduce work that will be generated at the time of changing a flow. Examples of the work include understanding of connection specifications, program modification and program distribution, which would be implemented through many processes required in conventional methods.

Lastly, the mapping definition 2800 will be described.

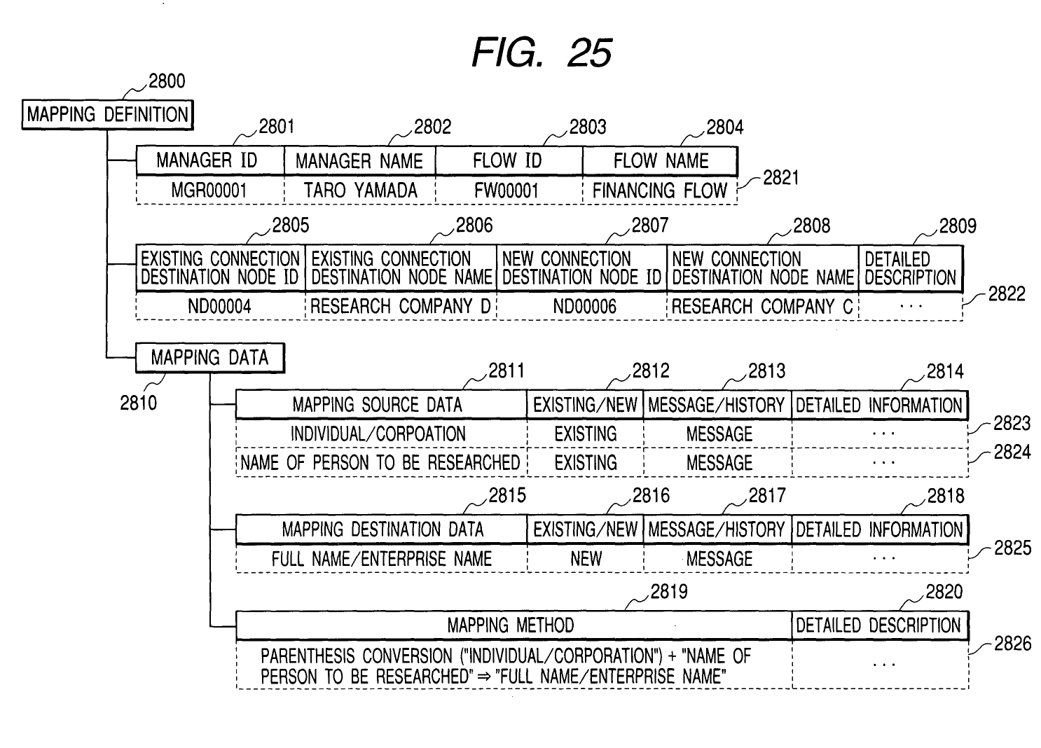

As shown in FIG. 25, the mapping definition 2800 includes a manager ID 2801, a manager name 2802, a flow ID 2803, a flow name 2804, an existing connection destination node ID 2805, an existing connection destination node name 2806, a new connection destination node ID 2807, a new connection destination node name 2808, detailed description 2809 of the mapping definition 2800 by use of a free format, and mapping data 2810 which stores information related to mapping procedures. In an example 2821, the manager ID is “MGR0001”, the manager name 2802 is “Taro YAMADA”, the flow ID 2803 is “FW00001”, and the flow name 2804 is “financing flow”, and in an example 2822, the existing connection destination node ID 2805 is “ND00004”, the existing connection destination node name 2806 is “research company D”, the new connection destination node ID 2807 is “ND00006”, and the new connection destination node name 2808 is “research company C.”

Mapping data 2810 includes a plurality of mapping source data records, a plurality of mapping destination data records, and a mapping method record.

The mapping source data records include mapping source data 2811, existing/new 2812, message/history 2813, and a detailed description 2814 of the mapping source data records by use of a free format. In an example 2828, the mapping source data 2811 is “individual/corporation”, the existing/new 2812 is “existing”, the message/history 2813 is “message”, and in an example 2824, the mapping source data 2811 is “name of person to be researched”, the existing/new 2812 is “existing”, the message/history 2813 is “message.”

The mapping destination data records include mapping destination data 2815, existing/new 2816, message/history 2817, and a detailed description 2818 of the mapping destination data records by using a free format. In an example 2825, the mapping destination data 2815 is “full name/enterprise name”, the existing/new 2816 is “new”, and the message/history 2817 is “message.”

The mapping method record includes a mapping method 2819 and a detailed description 2820 of the mapping method by using a free format. In an example 2826, the mapping method 2819 is “parenthesis conversion (“individual/corporation grouping”+“name of person to be researched” [symbol] “Full name/enterprise name.” It should be noted that the operation method will not be described here in detail since it has already been referred to in the aforementioned description of the mapping definition creation screen 1300.

Lastly, in the “new flow formation phase”, the following processing is executed.

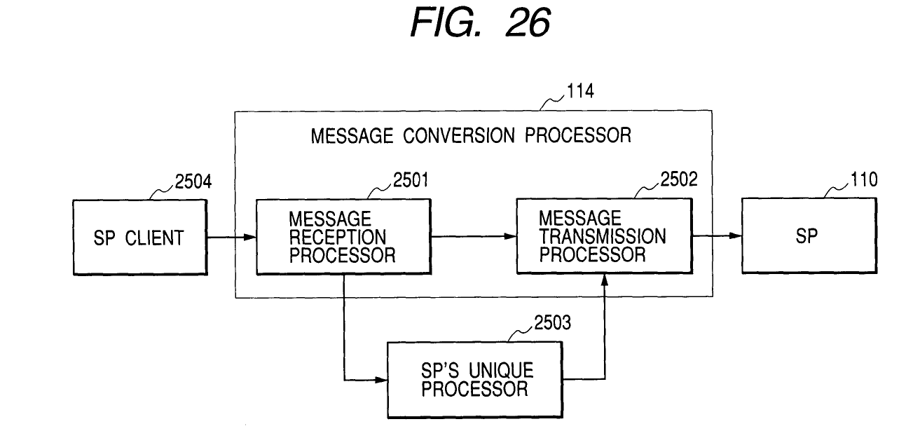

As shown in FIG. 26, a message conversion processor 144, upon receiving a message from an existing SP 110 or an SP client 2504 showing a service user, first judges if the message received is an existing message or a new message at a message reception processor 2501. If the message received is an existing message, the processor 144 transfers the message to an SP's unique processor 2503 as it is, and if the message is a new message, the processor 144 processes the message by using a connection stab that is generated in the connection stab generator 420 based on the mapping definition 2800 and transfers the message to the SP's unique processor 2503. The SP's unique processor 2503, after executing unique processing as an SP, transfers a transmission message to a message transmission processor 2502, if another SP is to be called.

Further, when such a change flow that processing is transferred from the debt collection 907 to the large customer debt collection 911 or the small customer debt collection 912, the message conversion processor 144, after executing classification processing (classification of a large customer or a small customer) of a message by using a connection stab, transfers the message directly to the message transmission processor 2502 bypassing the SP's unique processor 2503.

Upon receiving the message, the message transmission processor 2502 judges if the transmission destination is an existing destination or a new destination. If the destination is an existing destination, the processor 2502 executes the transmission processing as it is, and if the destination is a new destination, the processor 2502 transmits the message to the new connection destination after processing the message by using the connection stab that has been generated in the processing for the connection stab generation 420 based on the mapping definition 2800.

The above-stated processing will be executed for returning the message in the same way, but in reverse order of the procedures.

Hereinafter, detailed processing methods of the message reception processor 2501 and the message transmission processor 2502 will be described.

With such arrangement, the connection destination can be changed without affecting the existing SP's unique processor.

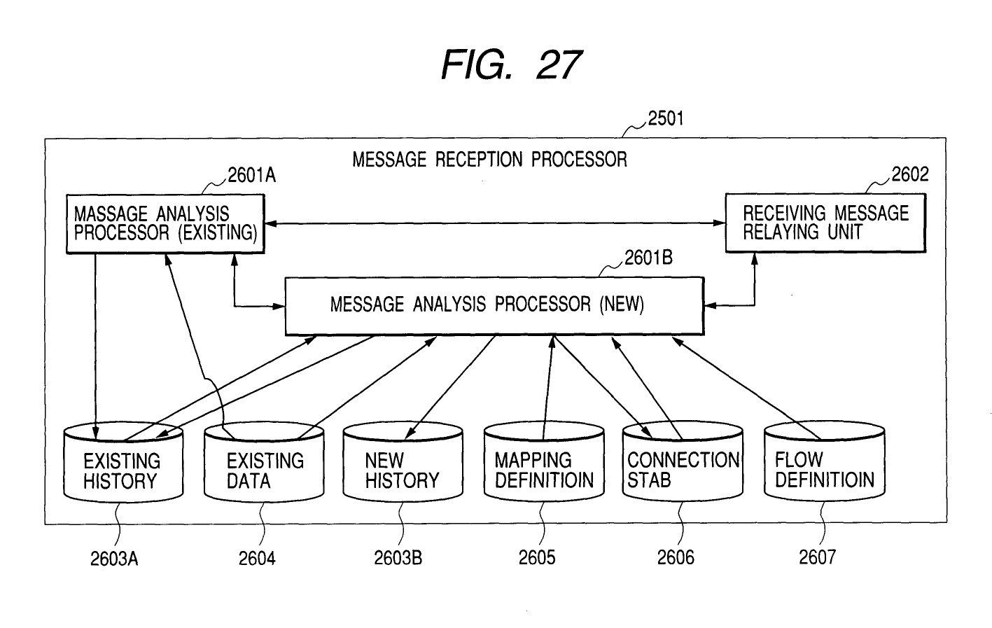

As shown in FIG. 27, the message reception processor 2501, upon receiving a receiving message, stores a reception history in an existing history 2603A at a message analysis processor (existing) 2601A, acquires data for message analysis from existing data 2604, and analyzes the message. If the message thus received is an existing message, the processor 2501 transfer the message to a reception message relaying unit 2602 as it is, or if the message is a new message, the processor 2501 transfers an appropriate message to a message analysis processor (new) 2601B which can process the message.

The message analysis processor (new) 2601B, if a connection stab 2606 which analyzes the message received already exists, loads the connection stab 2606, or if such stab does not exist, the processor 2601B loads a mapping definition 2605 or a flow definition 2607, newly generates a connection stab 2606 and stores the stab. Thereafter, by using the connection stab 2606 and by using the existing message received, the existing history 2603A or the existing data 2604, the processor 2601B creates a new message and a new reception history. Then, the new reception history is stored in the new history 2603B, and the new message is transferred to the receiving message relaying unit 2502.

The above-stated processing will be executed for returning the message in the same way, but in reverse order of the procedures. It should be noted that when data is acquired for the existing history 2603A at the time of returning the message, the message analysis processor (new) 2601B stores the data pertinent to the existing history 2603A after processing the message or the history that is available at the time of returning the message.

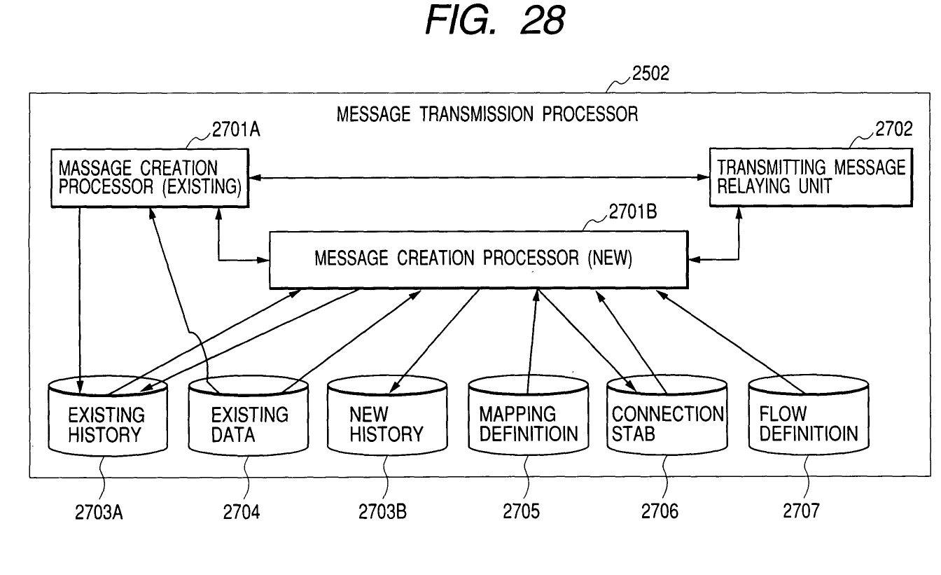

As shown in FIG. 28, the message transmission processor 2502, upon receiving a transmitting message, stores a transmission history in an existing history 2703A at a message creation processor (existing) 2701A, acquires data for message creation from existing data 2704, and creates a message. If the message to be transmitted is an existing message, the processor 2502 transfer the message to a transmission message relaying unit 2702 as it is, or if the message is a new message, the processor 2502 transfers an appropriate message to a message creation processor (new) 2701B which can process the message.

The message creation processor (new) 2701B, if a connection stab 2706 which creates the message to be transmitted already exists, loads the connection stab 2706, or if such stab does not exist, the processor 2601B loads a mapping definition 2705 or a flow definition 2707, newly generates a connection stab 2706 and stores the stab. Thereafter, by using the connection stab 2706 and by using the existing message to be transmitted, the existing history 2703A or the existing data 2704, the processor 2701B creates a new message and a new transmission history. Then, the new transmission history is stored in the new history 2703B, and the new message is transferred to the transmitting message relaying unit 2702.

The above-stated processing will be executed for receiving the message in the same way, but in reverse order of the procedures. It should be noted that when data is acquired for the existing history 2703A at the time of receiving the message, the message creation processor (new) 2701B stores the data pertinent to the existing history 2703A after processing the message or the history that is available at the time of receiving the message.

With such arrangement, monitoring/evaluation information designator 133 stores a message and a history that is generated during communication processing for using each service provider, designates a message and a history to be monitored. In addition, the business service information collector on each service provider sends information to be monitored to a business level analyzer each time a transaction occurs. Next, the business service level analyzer evaluates the business service based on the information collected.

Thereafter, the manager 120 identifies a problematic business service, or a business flow based on the evaluation index (BSL information), and requests the business process management for retrieving an alternative business service or a business flow. At this time, the business process management retrieves a business service or a business flow that matches the retrieval conditions from the registry, and notifies the manager of the result. Lastly, the manager transmits an instruction to each service provider via the business process management to change the business flow.

With such arrangement, it will become possible to monitor/evaluate a service that is provided by a service provider at a business level. Consequently, a manager will be able to easily grasp problems of a business flow. In addition, it will be easy for the manager to change the business flow according to an evaluation index.

In this way, in an enterprise which has built a business flow utilizing a plurality of service providers, it will be possible, by using a system to be used by a manager, to monitor/evaluate a service that is provided by the service providers, and further burdens to be incurred at the time of improving the business flow according to an evaluation index can be reduced.

As stated in the above, the present invention offers effects that, in an enterprise which has built a business flow utilizing a service provider, it will be possible for a manager to monitor/evaluate a service that is provided by the service provider, and further burdens to be incurred in changing a business flow are reduced, thus enabling enhancement of the business efficiency and increase of added values.

According to the present invention, in a business flow utilizing a service provider, it is possible to monitor/evaluate a service that is provided by a service provider at a business level and also to reduce burdens in terms of a change in the business flow.

1. A method for evaluating a service provider by using a computer, said computer implementing the steps of:
storing information on an item of data of a history related to a transaction that is acquired by said service provider when a service provided by said service provider is used;
storing items to be monitored including an item of data used for evaluating the service provided by said service provider;
acquiring the history data related to a transaction acquired by said service provider from said service provider;
evaluating the service provided by said service provider based on the acquired history data related to a transaction that is acquired by said service provider and on the item of data included in said items to be monitored; and
outputting a result of said evaluation.

2. A method for evaluating a service provider according to claim 1, wherein data included in said items to be monitored is extracted at the time of acquiring the history data related to a transaction acquired by said service provider from said service provider; and
said extracted data is transmitted to another computer which satisfies a predetermined condition.

3. A method for evaluating a service provider by using a computer, said computer implementing the steps of:
storing information on an item of data of a message that is sent and received by said service provider;
storing items to be monitored including an item of data used for evaluating a service provided by said service provider;
acquiring the data of the message that is sent and received by said service provider from said service provider;
evaluating the service provided by said service provider based on the acquired data of the message that is sent and received by said service provider and on the acquired data included in said items to be monitored; and
outputting a result of said evaluation.

4. A method for evaluating a service provider by using a computer, said computer implementing the steps of:
storing information on an item of data of a message that is sent and received by said service provider;
storing information on an item of data of a history related to a transaction that is acquired by said service provider when a service provided by said service provider is used;
storing items to be monitored including an item of data used for evaluating the service provided by said service provider;
acquiring the data of a history related to a transaction that is acquired by said service provider and the data of a message that is sent and received by said service provider from said service-provider;
evaluating the service provided by said service provider based on the acquired history data related to a transaction acquired at said service provider, the data of a message that is sent and received by said service provider and the item of data included in said items to be monitored; and
outputting the result of said evaluation.

5. A system for evaluating a service provider, said system comprising:
means for storing information on an item of data of a history related to a transaction to be acquired by said service provider when a service provided by said service provider is used;
means for storing items to be monitored including an item of data used for evaluating the service provided by said service provider;
means for acquiring the data of a history related to a transaction to be acquired by said service provider from said service provider;
means for evaluating the service provided by said service provider based on the acquired data of a history related to a transaction acquired by said service provider, and the item of data included in said items to be monitored; and
means for outputting a result of said evaluation.

6. A business support management system which supports a change in a business flow that uses a plurality of service providers providing a service to execute a business processing by using a computer, said system comprising:
a business service information registry which stores information related to a connection specification which defines a data structure of a message to be sent and received, stores information related to a history specification which defines a data structure of a history related to a transaction to be acquired in said service providers when said service is used, stores information related to a flow definition which defines said business flow, and stores business service evaluation information on a service to be provided by said service provider, when a connection is made to said service providers and said service is provided;
a business service information collector which stores items to be monitored consisting of definition information on items used for evaluating said service, among said connection specification and said history specification, collects information that is pursuant to said items to be monitored from said service provider each time said service provider processes a request for using said service, and transmits said collected information to another computer which satisfies a specific condition as business service information;
a business service evaluation analyzer which collects said business service information from said service provider through said business service information collector, performs tabulation of such business service information, and then stores a result of said tabulation in said business service information registry as said business service evaluation information;
a monitoring/evaluation information designator which notifies said business service information collector and said business service evaluation analyzer of said items to be monitored and a definition of business service evaluation information;
an access controller which permits an access to said business service evaluation information that is stored by said business service information registry to a user of said service who satisfies a specific condition;
business process management which, with said connection specification, said history information, said flow definition and said business service evaluation information that are stored by said business service information registry being retrieval conditions, retrieves said service provider or a service to be provided by said service provider, defines data processing change procedure information which is used to connect components of said business flow and components of business flow after subjected to a change when the components of said business flow is to be changed, and notifies components of a business flow which will be connected to the components of the business flow after subjected to a change of said data processing change procedure information; and
a message conversion processor which changes a connection procedure with the components of the business flow after subjected to said change based on said data processing change procedure information.

7. A business service management system according to claim 6, wherein the components of said business flow include at least one of a sub-flow, a service provider, a service provided by a service provider, a computer for executing a service to be provided by a service provider, and a program for executing a service to be provided by a service provider.

8. A business service management system according to claim 6, wherein said monitoring/evaluation information designator includes:
means for determining said items to be monitored by acquiring, from said business service information registry, said connection specification and said history specification of said service provider to be monitored;
means for determining a definition of said business service evaluation information that is used by said business service evaluation analyzer to collect business service information for processing from said items to be monitored; and
means for notifying said business service evaluation analyzer of said items to be monitored and definition of said business service evaluation information.

9. A business service management system according to claim 6, wherein said business service evaluation analyzer includes:
means for registering said business service evaluation information in said business service information registry;
means for notifying said business service information collector of the definition of said business service evaluation information and said items to be monitored so as to monitor said items to be monitored; and
means for determining access authority to refer to said business service evaluation information.

10. A business service management system according to claim 6, said business service information collector includes:
means for authenticating said business service information collector to determine whether said items to be monitored notified from a pertinent business service evaluation analyzer may or may not be sent to a pertinent business service evaluation analyzer;
means for determining access authority to refer to said business service evaluation information; and
means for recording an instruction to monitor said items to be monitored.

11. A business service management system according to claim 6, wherein said service provider includes:
means for allowing said business service collector to collect information, every time said messages containing information pertinent to said items to be monitored are sent and received, that is pertinent to such items to be monitored out of such messages; and
means for allowing said business service collector to collect information, every time said sending and receiving processing is encountered, that is pertinent to said items to be monitored out of a history.

12. A business service management system according to claim 6, wherein said business service collector includes:
means for determining a transmission destination business service evaluation analyzer of information pertinent to said collected items;
means for determining whether or not information pertinent to said collected items to be monitored should be sent to said transmission destination business service evaluation analyzer; and
means for decrypting information pertinent to said collected items to be monitored as said business service information, and then sending such encrypted information to said transmission destination business service evaluation analyzer.

13. A business service management system according to claim 6, wherein said business service evaluation analyzer includes:
means for decrypting said business service information received;
means for repeating said reception processing until all said business service information collected from a plurality of transactions that are sent and received among said plurality of service providers or among said services are received, putting said business service information received together according to one said transaction, and storing such information as said business service information for the entire business flow, in order to realize one said service;
means for repeating said reception processing until all said business service information acquired from said plurality of transactions that realize one business, putting said business service information received together according to one said business, and storing such information as said business service information for the entire business;
means for collecting said service information and creating said business service evaluation information; and
means for registering said created business service evaluation information in said business service information registry.

14. A business service management system according to claim 6, wherein said business process management includes:
means for retrieving said service provider, said service, or said sub-flow substituting for designated said service provider, said service or said flow from said business service information registry, with said business service evaluation information, said connection specification, said history specification and said flow definition being as retrieval conditions;
means for acquiring said history specification and said connection specification of said service provider which works as said client or said server to said designated service provide, service or sub-flow, said service provider which is selected out of said sub-flows and said retrieval results, and said service or said flow;
means for creating said data processing change procedure information which is used to change said designated service provider, service or sub-flow to said selected service provider, service, or sub-flow;
means for uploading said created data processing change procedure information to a service provider to which a connection destination will be changed; and
means for transmitting an instruction to change connection destination to said service provider to which connection destination will be changed.

15. A business service management system according to claim 14, wherein said service provider to which connection destination will be changed includes:
means for generating a connection program based on said data processing change procedure information received;
means for stopping a service based on said instruction to change the connection destination received; and
means for capturing said connection program, with the program booted, and changing the connection destination.

16. A business service management system according to claim 6, wherein said message conversion processor includes:
means for judging whether said message received is an existing message before changing a flow or a new message that was generated according to a change of connection destination;
means for transferring said message to a processor unique to said service provider if said judgment result reveals that said message is an existing message;
means for transferring such new message to said processor unique to said service provider after processing the new message by using said connection program, if said judgment result reveals that said message is said new message and processing will be executed in said processor unique to said processor;
means for receiving such new message processed by said connection program, if said judgment result reveals that said message is said new message and such processing unique to said service provider will be outsourced; and
means for judging whether the transmission destination of said message is an existing service or a new service, executing transmission of said message received if the transmission destination is an existing service, or transmitting said message received to a new connection destination after processing said new message by using said connection program if the transmission destination is a new service.
